(19) United States
(12) Patent Application Publication
(10) Pub. No.: US 2010/0003005 A1
(43) Pub. Date: Jan. 7, 2010

(54) DATA PROCESSING DEVICE, DATA PROCESSING METHOD, DATA PROCESSING PROGRAM AND RECORDING MEDIUM INCLUDING PROGRAM RECORDED THEREIN

(75) Inventors: Motooki Sugihara, Saitama (JP); Hiroshi Iwamura, Saitama (JP); Hiroshi Yamazaki, Saitama (JP)

Correspondence Address: KRATZ, QUINTOS & HANSON, LLP, 1420 K Street, N.W., Suite 400, WASHINGTON, DC, 20005, US

(73) Assignee: PIONEER CORPORATION, Tokyo (JP)

(21) Appl. No.: 12/301,107

(22) PCT Filed: May 16, 2007
(86) PCT No.: PCT/JP2007/060006

§ 371 Date: Feb. 23, 2009

(30) Foreign Application Priority Data
May 18, 2006 (JP) 2006-139557

(51) Int. Cl. H04N 9/87; H04N 5/911

(52) U.S. Cl. 386/4; 386/52; 386/E05.04; 386/E09.05

(57) ABSTRACT

An editing device selects, among the video of the video data, a scene such as a backlit scene and a camera shake scene which has a characteristic different from a necessary scene, as an unnecessary scene, and reproduces the selected unnecessary scene on a display unit. Accordingly, the editing device allows the user to select necessary scenes and unnecessary scene from among the camera shake scenes or the backlit scenes. In addition, for example, if a camera shake scene is present in similar videos that are captured at substantially identical locations, the user can recognize that the camera scene is present without conducting an operation to select the camera shake scene.

### TECHNICAL FIELD

The present invention relates to a data processor for processing video data of captured video, a method for the same, a program of the same, and a recording medium on which the program is recorded.

### BACKGROUND ART

Conventionally, an arrangement for processing video data is known (see, e.g., Patent Documents 1 and 2).

According to Patent Document 1, a video structure and a metadata are extracted from a video data sequence. Based on the metadata, a frame sequence having an inferior color entropy, an abnormal action analysis result, or the like is removed to create a video abstract.

According to Patent Document 2, broadcast news programs are classified to groups respectively having similar images. For example, the news programs are classified to scenes in which an announcer is on screen and scenes of news video. When the classification results are displayed on the display system, classification, time, and reproduced position are displayed. At this time, the similar image scenes having a large classification frequency are displayed in, e.g., red, and the other scenes are displayed in, e.g., blue.

Patent Document 1. JP-A-2004-159331 (page 18)

Patent Document 2: JP-A-2002-344852 (page 4 left column—page 11 left column)

### DISCLOSURE OF THE INVENTION

### Problems to Be Solved by the Invention

In recent years, as portable capturing devices become common, a user may capture a landscape and edit the data to improve the quality of the captured video for oneself. Here, arrangements disclosed in the above-mentioned Patent Documents 1 and 2 may be applied to such editing.

However, if the arrangement of Patent Document 1 is employed, because an abstract in which the inferior images have been removed is created, an image that is inferior but is necessary for the user, for example, an image that is shaky but is necessary for the user may be deleted against the user's will.

If the arrangement of the Patent Document 2 is employed, even when an image that the user feels unnecessary, for example, a shaky image, is contained in the similar images, such an image is classified to be similar to other images that are not shaky. It may be cumbersome to select unnecessary images from the similar images.

In view of the above circumstances, an object of the invention is to provide a data processor for facilitating editing of appropriate video data, a method for the same, a program of the same, and a recording medium on which the program is recorded.

### Means for Solving the Problems

A data processor according to an aspect of the invention is a data processor that processes video data for displaying video captured by a capturing device, the data processor including: a video data obtainment unit that obtains the video data; a characteristic analysis unit that analyzes a characteristic of video of the video data obtained; an identification unit that identifies, as an unnecessary scene, a scene of the characteristic that is obtained by analyzing and is out of a range of a predetermined reference value; a selection unit that selects, from the video data, unnecessary scene data for displaying the unnecessary scene; and a display control unit that controls a display unit to display the unnecessary scene based on the unnecessary scene data selected.

A data processing method according to another aspect of the invention is a data processing method for a computer to process video data for displaying video captured by a capturing device, the method including: obtaining the video data by the computer; analyzing a characteristic of video of the video data obtained by the computer; identifying a scene of a characteristic that is obtained by the analyzing and is out of a range of a predetermined reference value as an unnecessary scene by the computer; selecting, from the video data, unnecessary scene data for displaying the unnecessary scene by the computer; and controlling the display unit to display the unnecessary scene based on the unnecessary scene data selected by the computer.

A data processing program according to still another aspect of the invention is a data processing program in which the above-mentioned data processing method is executed on a computer.

On a recording medium on which a data processing program is recorded according to still another aspect of the invention, the above-mentioned data processing program is recorded in a manner readable by a computer.

### BRIEF DESCRIPTION OF DRAWINGS

FIG. 1 is a block diagram showing a schematic arrangement of an editing device in first and fourth embodiments of the invention.

FIG. 2 is a block diagram showing a schematic arrangement of a scene classifying unit in the first embodiment and a modification of the first embodiment.

FIG. 3 is a conceptual diagram schematically showing a table structure of data in a characteristic reference value information table in the first and fourth embodiments and second and third embodiments.

FIG. 4 is a conceptual figure schematically showing a table structure of scene attribute information with respect to an unnecessary scene in the first to fourth embodiments.

FIG. 5 is a block diagram showing a schematic arrangement of a scene selection unit in the first and second embodiments.

FIG. 6 is a conceptual diagram schematically showing a table structure of data in an icon related information table in the first to fourth embodiments.

FIG. 7 is a timing chart showing actions during normal reproduction processing and abstract reproduction processing of an unnecessary scene in the first, second, and fourth embodiments. A portion (A) shows the action during the normal reproduction processing, and a portion (B) shows the action during the abstract reproduction processing.

FIG. 8 is a schematic diagram showing a schematic arrangement of a delete selection screen in the first, second, and fourth embodiments.

FIG. 9 is a flowchart showing creation processing of editing data in the first embodiment.

FIG. 10 is a flowchart showing first scene classification processing in the creation process of the editing data.

FIG. 11 is a flowchart showing first scene selection processing in the creation processing of the editing data.

FIG. 12 is a block diagram showing a schematic arrangement of an editing device in the second embodiment.

FIG. 13 is a block diagram showing a schematic arrangement of a scene classification unit in the second embodiment and a modification of the second embodiment.

FIG. 14 is a flowchart showing a creation process of editing data in the second embodiment.

FIG. 15 is a flowchart showing second scene classification processing in the creation processing of the editing data.

FIG. 16 is a block diagram showing a schematic arrangement of an editing device in the third embodiment.

FIG. 17 is a block diagram showing a schematic arrangement of a scene classification unit in the third embodiment and a modification of the third embodiment.

FIG. 18 is a block diagram showing a schematic arrangement of a scene selection unit in the third embodiment.

FIG. 19 is a timing chart showing an action during normal reproduction processing and abstract reproduction processing of an unnecessary scene and a correction scene in the third embodiment, where a portion (A) shows the action during the normal reproduction processing of the unnecessary scene, a portion (B) shows the action during the abstract reproduction processing of the unnecessary scene, a portion (C) shows the action during the abstract reproduction processing of the correction scene, and a portion (D) shows the action during the normal reproduction processing of the correction scene.

FIG. 20 is a schematic diagram showing a schematic arrangement of a delete selection screen in the third embodiment.

FIG. 21 is a flowchart showing creation processing of editing data in the third embodiment.

FIG. 22 is a flowchart showing second scene selection processing in the creation processing of the editing data.

FIG. 23 is a block diagram showing a schematic arrangement of a scene classification unit in the fourth embodiment.

FIG. 24 is a block diagram showing a schematic arrangement of a scene selection unit in the fourth embodiment.

FIG. 25 is a flowchart showing creation processing of editing data in the fourth embodiment.

FIG. 26 is a flowchart showing a third scene selection processing in the creation processing of the editing data.

FIG. 27 is a flowchart showing update processing of characteristic reference value information in the creation processing of the editing data.

FIG. 28 is a block diagram showing a schematic arrangement of an editing device in the modification of the first embodiment.

FIG. 29 is a schematic diagram showing a schematic arrangement of a delete selection screen in the modification of the first and second embodiments.

FIG. 30 is a block diagram showing a schematic arrangement of an editing device in the modification of the second embodiment.

FIG. 31 is a block diagram showing a schematic arrangement of an editing device in the modification of the third embodiment.

FIG. 32 is a schematic diagram showing a schematic arrangement of a delete selection screen in the modification of the third embodiment.

FIG. 33 is a timing chart showing an action during normal reproduction processing and abstract reproduction processing of an unnecessary scene and a correction scene in another modification of the invention, where a portion (A) shows the action during the normal reproduction processing of the unnecessary scene, a portion (B) shows the action during the abstract reproduction processing of the unnecessary scene, a portion (C) shows the action during the abstract reproduction processing of the correction scene, and a portion (D) shows the action during the normal reproduction processing of the correction scene.

### EXPLANATION OF CODES

33, 38 . . . characteristic parameter reference information
50 . . . scene attribute information as characteristic content information
100A, 100B, 100C, 100D, 100E, 100F, 100G . . . editing device as data processor
110 . . . display unit
120 . . . input unit
141 . . . characteristic reference value temporary storage unit as reference information storage unit
142 . . . video data obtainment unit
144 . . . characteristic analysis unit
144A . . . color characteristic analysis unit
144B . . . action characteristic analysis unit
144C . . . spatial frequency characteristic analysis unit
146, 211, 261 . . . characteristic comparison unit as identification unit
147, 212, 262 . . . classification distribution unit as selection unit
153, 282 . . . abstract reproduction unit as display control unit
154, 283, 322 . . . GUI (Graphical User Interface) as display control unit and necessity decision unit
160, 230 . . . scene sort unit as editing data creation unit
220, 270 . . . scene correction unit
311 . . . characteristic reference value update unit as reference information update unit

### BEST MODE FOR CARRYING OUT THE INVENTION

### First Embodiment

A first embodiment of the invention will be described below with reference to the drawing. In the first embodiment and the second to fourth embodiments that will be described below, an arrangement will be exemplarily described, in which unnecessary scene data that may be decided to be unnecessary by a user is selected from video data to be displayed, and unnecessary data decided to be unnecessary by the user is deleted to create editing data.

Examples of the unnecessary scene include a very shaky scene, a scene in which a fast one of a so-called pan or a so-called zoom is present, a scene captured against the light, a poorly focused scene, a scene in which an unintended object is captured, and a scene in which video continues for a predetermined period with little movement.

Note that scenes in video of video data other than the unnecessary scenes, that is, scenes that may be decided to be necessary by the user will be referred to as necessary scenes in the following description.

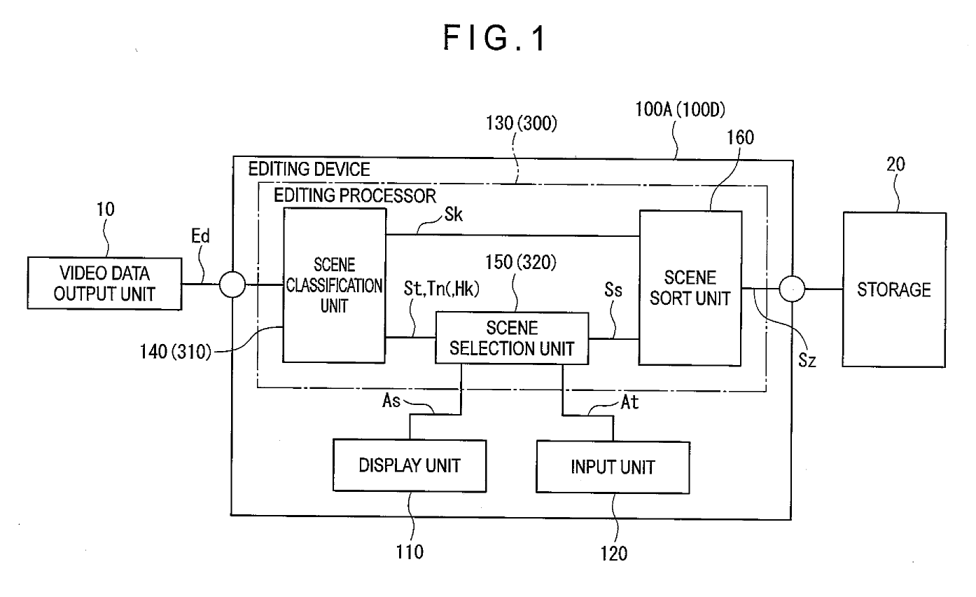

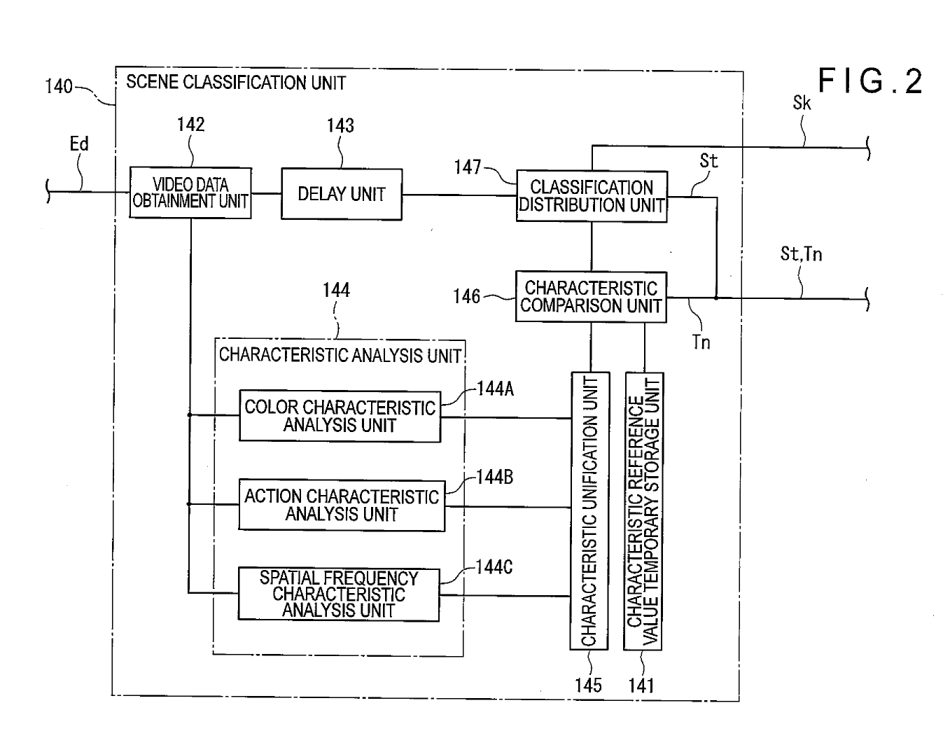

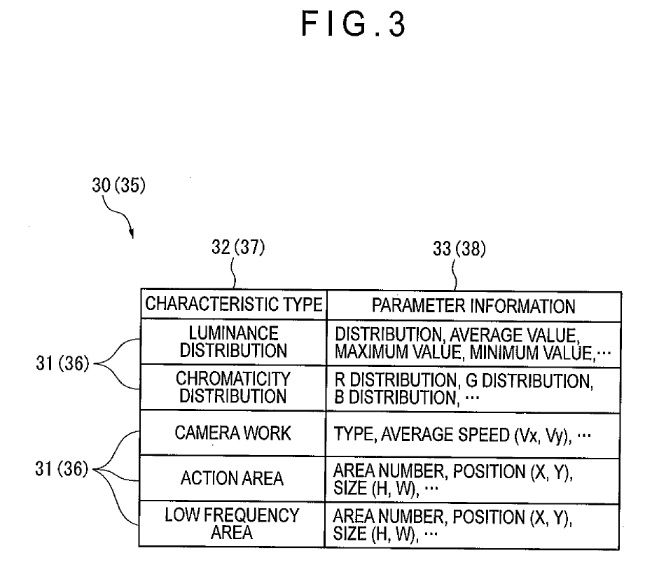

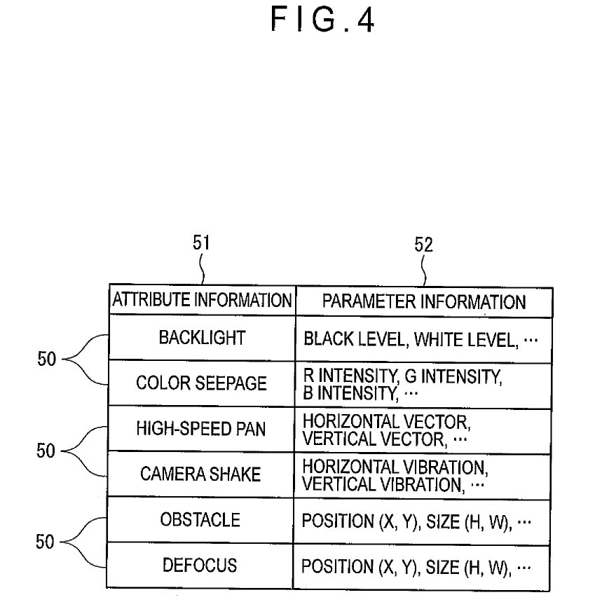

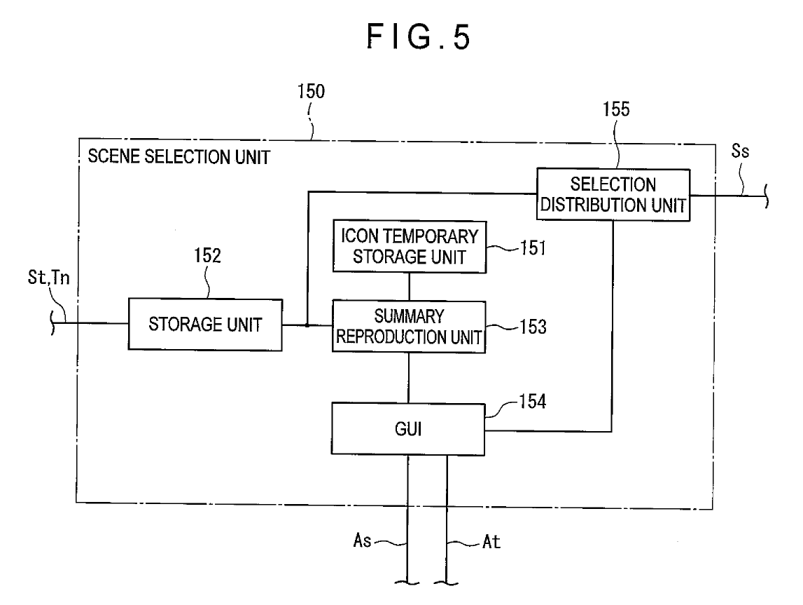

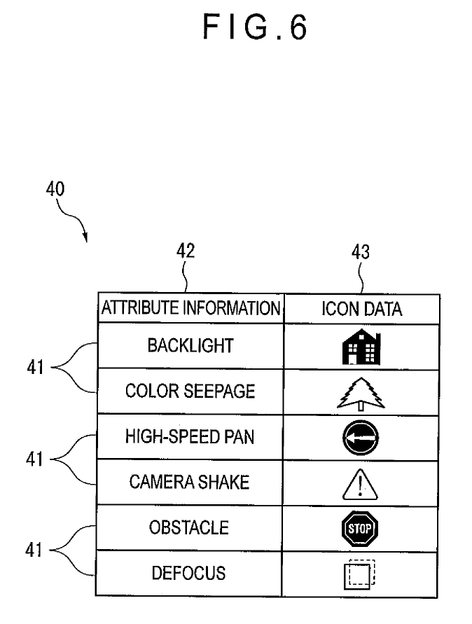

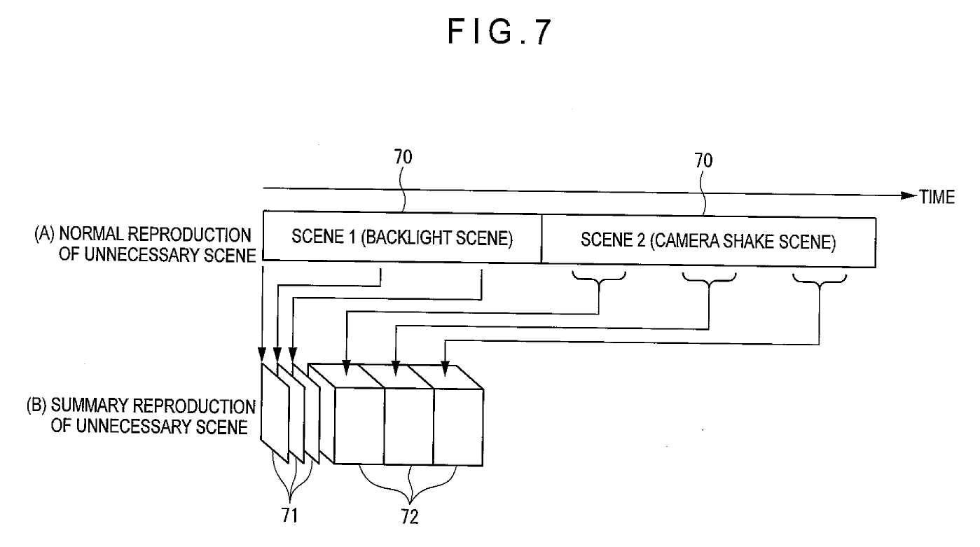

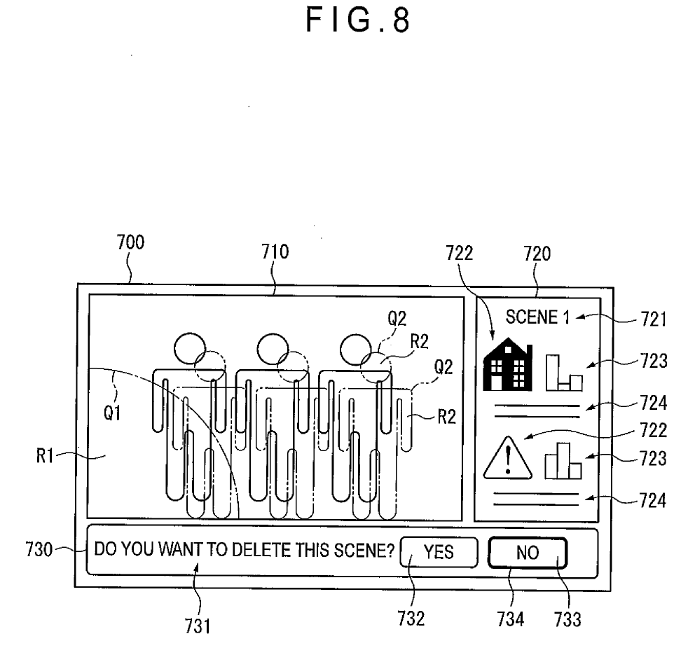

FIG. 1 is a block diagram showing a schematic arrangement of an editing device in the first and fourth embodiments of the invention. FIG. 2 is a block diagram showing a schematic arrangement of a scene classification unit in the first embodiment and a modification of the first embodiment. FIG. 3 is a conceptual diagram schematically showing a table structure of data in a characteristic reference value information table in the first to fourth embodiments. FIG. 4 is a conceptual figure schematically showing a table structure of scene attribute information with respect to an unnecessary scene in the first to fourth embodiments. FIG. 5 is a block diagram showing a schematic arrangement of a scene selection unit in the first and second embodiments. FIG. 6 is a conceptual diagram schematically showing a table structure of data in an icon related information table in the first to fourth embodiments. FIG. 7 is a timing chart showing actions during normal reproduction processing and abstract reproduction processing of an unnecessary scene in the first, second, and fourth embodiments, where a portion (A) shows the action during the normal reproduction processing, and a portion (B) shows the action during the abstract reproduction processing. FIG. 8 is a schematic diagram showing a schematic arrangement of a delete selection screen in the first, second, and fourth embodiments.

Arrangement of Editing Device

In FIG. 1, 100A denotes an editing device (a data processor). The editing device 100A selects the unnecessary scene data from video data to display the unnecessary data and creates editing data from which the unnecessary scene data has been deleted based on decision by the user.

The editing device 100A includes a display unit 110, an input unit 120, and an editing processor 130.

The display unit 110 is controlled by the editing processor 130 and displays on the screen an image signal As for displaying a predetermined image from the editing processor 130. Examples of the display unit 110 include a liquid crystal panel, an organic EL (electroluminescence) panel, a PDP (plasma display panel), a CRT (cathode-ray tube), an FED (field emission display), and an electrophoretic display panel.

Examples of an image displayed on the display unit 110 include: an unnecessary scene; and a delete selection screen 700 (see, FIG. 8) for the user to select whether or not to delete the unnecessary scene.

The input unit 120 exemplarily is a keyboard and a mouse and suitably has manipulation buttons, manipulation tabs, or the like for input manipulation (not shown). The input manipulation of the manipulation buttons, the manipulation tabs, or the like includes inputting specific actions of the editing device 100A and inputting whether or not to delete an unnecessary scene.

When settings are inputted, the input unit 120 suitably outputs an input signal At corresponding to the settings to the editing processor 130 where the input signal At is inputted. Incidentally, the input manipulation is not limited to the manipulation of the manipulation buttons, the manipulation tabs, or the like, but exemplarily includes input manipulation of a touch panel provided on the display unit 110 and an audio input manipulation.

The editing processor 130 is connected to a video data output unit 10 and a storage 20.

The editing processor 130 obtains video data exemplarily captured by a capturing device (not shown) outputted as an image signal Ed from the video data output unit 10. Furthermore, the editing data from which unnecessary scene data has been suitably deleted from the video data is created and outputted to the storage 20 as an editing signal Sz. The editing data is stored in the storage 20. Incidentally, examples of the storage 20 include a drive or a driver that readably stores data on a recording medium such as an HD (hard disc), a DVD (digital versatile disc), an optical disc, or a memory card.

The editing processor 130 includes a scene classification unit 140, a scene selection unit 150, and a scene sort unit 160.

The scene classification unit 140 is connected to the video data output unit 10, the scene selection unit 150, and the scene sort unit 160 as an editing data creation unit.

The scene classification unit 140 classifies the video data of the image signal Ed to unnecessary scene data and necessary scene data and outputs the unnecessary scene data and the necessary scene data.

As shown in FIG. 2, the scene classification unit 140 includes: a characteristic reference value temporary storage unit 141 as a reference information storage unit; a video data obtainment unit 142; a delay unit 143; a characteristic analysis unit 144; a characteristic unification unit 145; a characteristic comparison unit 146 as an identification unit; a classification distribution unit 147 as a selection unit.

The characteristic reference value temporary storage unit 141 is connected to the characteristic comparison unit 146.

The characteristic reference value temporary storage unit 141 stores a characteristic reference value information table 30 as shown in FIG. 3 in a suitably readable manner.

The characteristic reference value information table 30 includes at least one piece of characteristic reference value information 31. The characteristic reference value information 31 is information regarding the standard of a predetermined characteristic referred to when a predetermined scene is identified as an unnecessary scene.

The characteristic reference value information 31 is formed as a piece of data in which characteristic information 32, characteristic parameter reference information 33, and the like are associated with each other.

The characteristic information 32 is formed by video characteristics outputted from the characteristic analysis unit 144. Specifically, the characteristic information 32 includes: “luminance distribution” and “chromaticity distribution” outputted by a color characteristic analysis unit 144A that will be described below; “camera work” and “action area” outputted by an action characteristic analysis unit 144B; and “low frequency area” outputted by a spatial frequency characteristic analysis unit 144C.

The characteristic parameter reference information 33 records parameters that are referred to when an unnecessary scene is identified. In other words, when a parameter of a predetermined scene is in the standard range recorded in the characteristic parameter reference information 33, the scene is identified to be a necessary scene, and when a parameter of a predetermined scene is out of the standard range, the scene is identified to be an unnecessary scene.

The video data obtainment unit 142 is connected to the delay unit 143 and the characteristic analysis unit 144.

The video data obtainment unit 142 obtains the image signal Ed from the video data output unit 10 and outputs the video data of the image signal Ed to the delay unit 143 and the characteristic analysis unit 144.

The delay unit 143 is connected to the classification distribution unit 147.

The delay unit 143 obtains the video data from the video data obtainment unit 142. After delaying the video data for a time period that is substantially equal to time required for identification processing by the characteristic analysis unit 144, the characteristic unification unit 145, and the characteristic comparison unit 146, the delay unit 143 outputs the video data to the classification distribution unit 147.

The characteristic analysis unit 144 analyzes the characteristic of video of the video data. The characteristic analysis unit 144 includes: the color characteristic analysis unit 144A, the action characteristic analysis unit 144B, and the spatial frequency characteristic analysis unit 144C, which are each connected to the video data obtainment unit 142 and the characteristic unification unit 145.

The color characteristic analysis unit 144A analyzes the color characteristic of video determined by a capturing environment or the like of the video.

Specifically, the color characteristic analysis unit 144A analyzes histograms of brightness, tone, and saturation of color as the color characteristic of each scene.

The color characteristic analysis unit 144A associates the color characteristic values such as a distribution value, a maximum value, and a minimum value regarding the components of color with frame sequence information and outputs the associated values to the characteristic unification unit 145.

The action characteristic analysis unit 144B analyzes the action characteristic of video and recognizes therefrom items such as camera work in the capturing occasion and an area moving independently of the camera work.

Then, the action characteristic analysis unit 144B associates the recognized results regarding the camera work (e.g., type information such as pan, zoom, and fix, and speed information) and the recognized results regarding the action area (e.g., number of areas, or position, size, speed of each area) with the frame sequence information, and outputs the associated results to the characteristic unification unit 145.

The spatial frequency characteristic analysis unit 144C analyzes the spatial frequency characteristic of video.

Specifically, the spatial frequency characteristic analysis unit 144C calculates an FFT (fast Fourier transform) coefficient and a DCT (discrete cosine transform) coefficient of each division area of the video frames to analyze a local spatial frequency characteristic.

Then, the spatial frequency characteristic analysis unit 144C associates information regarding an area where the characteristic is extremely biased to low frequency (e.g., number of areas, and location and size of each area) with the frame sequence information, and outputs the associated information to the characteristic unification unit 145.

Incidentally, when at least two of the color characteristic information regarding the color characteristic, the action characteristic information regarding the camera work, and the spatial frequency characteristic information regarding the spatial frequency characteristic are collectively mentioned, such a combination will be collectively referred to as characteristic analysis information.

The characteristic unification unit 145 is connected to the characteristic comparison unit 146.

The characteristic unification unit 145 obtains the frame sequence information and individual characteristic analysis information associated with the frame sequence information from the characteristic analysis unit 144. Further, based on the frame sequence information, the characteristic unification unit 145 unifies the characteristic analysis information, which are obtained separately, to characteristic analysis information that corresponds to the same frame sequence. Then, the characteristic unification unit suitably outputs the frame sequence information and the unified characteristic analysis information to the characteristic comparison unit 146.

The characteristic comparison unit 146 is connected to the classification distribution unit 147 and the scene selection unit 150.

The characteristic comparison unit 146 obtains the frame sequence information and the characteristic analysis information from the characteristic unification unit 145. In addition, the characteristic comparison unit 146 obtains the characteristic reference value information table 30 from the characteristic reference value temporary storage unit 141. Then, the characteristic comparison unit 146 decides whether or not the characteristic indicated by the characteristic analysis information associated with the predetermined frame sequence information is in the standard range of the characteristic parameter reference information 33 of the characteristic reference value information table 30.

For example, if the camera work type information of the action characteristic information that corresponds to predetermined frame sequence information is pan, the characteristic comparison unit 146 decides whether or not camera work speed recorded in the action characteristic information is in the standard range of camera work speed recorded in the characteristic parameter reference information 33 for the case in which the camera work is pan.

If the characteristic comparison unit 146 decides that the camera work speed is in the standard range of the characteristic parameter reference information 33, the characteristic comparison unit 146 decides that the scene attribute of the frame sequence is normal pan. Further, if multiple pieces of the characteristic analysis information are associated with one piece of the frame sequence information, the characteristic comparison unit 146 decides whether the characteristic of each of the multiple pieces of the characteristic analysis information is in the standard range of the characteristic parameter reference information 33. Then, when the characteristic comparison unit 146 decides that all the characteristics are within the standard range, the characteristic comparison unit 146 identifies that a scene that corresponds to the frame sequence information is a necessary scene. Further, the characteristic comparison unit 146 associates identification information in which it is recorded that the scene is a necessary scene with the frame sequence information and outputs the associated information to the classification distribution unit 147.

If the characteristic comparison unit 146 decides that, among all the characteristic analysis information associated with the frame sequence information, a characteristic indicated by at least one piece of the characteristic analysis information is out of the standard range of the characteristic parameter reference information 33, the characteristic comparison unit 146 identifies that a scene of the frame sequence information is an unnecessary scene. Then, the characteristic comparison unit 146 associates identification information in which it is recorded that the scene is an unnecessary scene with the frame sequence information and outputs the associated information to the classification distribution unit 147.

Further, the characteristic comparison unit 146 creates scene attribute information 50 as characteristic content information as shown in FIG. 4 in a manner associated with the scene identified to be an unnecessary scene. For example, if the camera work is pan and the speed is greater than standard range of the characteristic parameter reference information 33, the characteristic comparison unit 146 creates scene attribute information 50 including attribute information 51 indicating that the camera work is a high-speed pan and parameter information 52 that represents the speed. Then, the characteristic comparison unit 146 associates the scene attribute information 50 with the frame sequence information and, as shown in FIGS. 1 and 2, converts the scene attribute information 50 into a scene attribute signal Tn to output to a scene selection unit 150.

As shown in FIGS. 1 and 2, the classification distribution unit 147 is connected to the scene selection unit 150 and the scene sort unit 160.

The classification distribution unit 147 obtains the frame sequence information and the identification information firm the characteristic comparison unit 146. Further, the classification distribution unit 147 obtains video data from the delay unit 143. Then, if the classification distribution unit 147 decides that identification information corresponding to the frame sequence information of the predetermined video frame data records that the video is a necessary scene, the classification distribution unit 147 converts the video frame data into a necessary scene signal Sk as necessary scene data to output to the scene sort unit 160.

On the other hand, if the classification distribution unit 147 decides that the identification information records that the video is an unnecessary scene, the classification distribution unit 147 converts the video frame data into unnecessary scene signal St as unnecessary scene data to output to the scene selection unit 150.

The scene selection unit 150 is connected to the display unit 110, the input unit 120, and the scene sort unit 160.

The scene selection unit 150 displays the unnecessary scene data on the display unit 110 and outputs the unnecessary scene data selected by the user as data not to be deleted to the scene sort unit 160 as selection scene data.

As shown in FIG. 5, the scene selection unit 150 includes an icon temporary storage unit 151, a storage unit 152, an abstract reproduction unit 153 as a display control unit, a GUI (graphical user interface) 154 as a display control unit and a necessity deciding unit, and a selection distribution unit 155.

The icon temporary storage unit 151 is connected to the abstract reproduction unit 153.

The icon temporary storage unit 151 stores an icon related information table 40 as shown in FIG. 6 in a suitably readable manner.

The icon related information table 40 includes the same number of the icon related information 41 as the attribute information 51 of the scene attribute information 50. The icon related information 41 is information regarding an icon that indicates attribute of the unnecessary scene on the delete selection screen 700.

The icon related information 41 is arranged as a piece of data formed by associating information such as the attribute information 42 containing contents similar to the attribute information 51 of the scene attribute information 50 and the icon data 43 which is used to display the icon.

The storage unit 152 is connected to the abstract reproduction unit 153 and the selection distribution unit 155. In addition, the storage unit 152 is connected to the characteristic comparison unit 146 and the classification distribution unit 147 of the scene classification unit 140.

The storage unit 152 obtains a scene attribute signal Tn from the characteristic comparison unit 146 and stores scene attribute information 50 of the scene attribute signal Tn. Then, the storage unit 152 suitably outputs the scene attribute information 50 to the abstract reproduction unit 153.

The storage unit 152 obtains an unnecessary scene signal St from the classification distribution unit 147 and stores unnecessary scene data of the unnecessary scene signal St. The storage unit 152 suitably outputs the unnecessary scene data to the abstract reproduction unit 153 and the selection distribution unit 155.

The abstract reproduction unit 153 is connected to the GUI 54.

The abstract reproduction unit 153 obtains the reproduction state signal that tells to conduct normal reproduction of unnecessary scene from the GUI 154 or to conduct abstract reproduction of the same and conducts the reproduction processing based on the reproduction state signal.

Specifically, when the abstract reproduction unit 153 conducts normal reproduction processing, the abstract reproduction unit 153 displays all the unnecessary scene data in the displaying order and controls all the unnecessary scenes to be reproduced as motion images.

As exemplarily shown in FIG. 7(A), if a scene 1 reproduced by an unnecessary scene data group 70 having a plurality of unnecessary scene data (not shown) is a backlit scene and a scene 2 reproduced by another unnecessary scene data group 70 is a camera shake scene, the abstract reproduction unit 153 reproduces all the unnecessary scenes as motion images based on all the unnecessary scene data groups 70 and outputs the scenes to the GUI 154 as reproduction information.

Further, the abstract reproduction unit 153 obtains the scene attribute information 50 from the storage unit 152 and extracts the icon data 43 that corresponds to the attribute of the unnecessary scene from the icon temporary storage unit 151. Then, the abstract reproduction unit 153 converts and processes these information into a state for displaying the delete selection screen 700 to output to the GUI 54.

On the other hand, when the abstract reproduction unit 153 conducts abstract reproduction processing, the abstract reproduction unit 153 suitably and selectively extracts the unnecessary scene data from the unnecessary scene data group 70 to control a portion of the unnecessary scenes to be reproduced as a motion image or a still image.

Specifically, if, based on the attribute information 51 of the scene attribute information 50, the abstract reproduction unit 153 recognizes that the attribute of the unnecessary scene is at least one of backlight, color seepage, an obstacle, and defocus, for example, the abstract reproduction unit 153 extracts the unnecessary scene data of the still image displayed every predetermined time, in other word, extracts unnecessary scene data that is substantially uncontinuous in the displaying order as the still image abstract scene data 71.

Also, if the abstract reproduction unit 153 recognizes that the attribute of the unnecessary scene is at least one of high speed pan and camera shake, the abstract reproduction unit 153, based on the scene attribute information 50, recognizes the unnecessary scene in which the characteristic of the attribute is the most prominent, for example, an unnecessary scene with a hard camera shake from among the plurality of unnecessary scene data. Then, the abstract reproduction unit 153 extracts the unnecessary scene data for displaying the unnecessary scene as a motion image, in other words, extracts a plurality of unnecessary scene data substantially continuous in the displaying order as the motion image abstract scene data 72.

As exemplarily shown in FIG. 7(B), the abstract reproduction unit 153 extracts still image abstract scene data 71 from the unnecessary scene data group 70 of backlit scene and extracts motion image abstract scene data 72 from the unnecessary scene data group of camera shake scene.

Then, the abstract reproduction unit 153 reproduces the backlit scenes based on the data as still images and the camera shake scene based on the data as motion images and outputs reproduction information to the GUI 154.

Further, the abstract reproduction unit 153 extracts, converts, and processes the scene attribute information 50 and the icon data 43 corresponding to the unnecessary scene data that undergo abstract reproduction, and the abstract reproduction unit 153 outputs the data to the GUI 154.

The GUI 154 is connected to the display unit 110, the input unit 120, and the selection distribution unit 155.

If the GUI 154 obtains an input signal At from the input unit 120, the GUI 154, based on the input signal At, recognizes the input of settings that normal reproduction or abstract reproduction of the unnecessary scenes is conducted. Then, the GUI 154 outputs reproduction state signals corresponding to the recognized content to the abstract reproduction unit 153.

If the GUI 154 obtains the reproduction information, the scene attribute information 50, and the icon data 43 from the abstract reproduction unit 153, the GUI 154 outputs, based on the obtained information, an image signal As for displaying the delete selection screen 700 as shown in FIG. 8 to the display unit 110.

Here, the delete selection screen 700 includes a reproduction video area 710, a scene attribute area 720, and a selection manipulation area 730.

The reproduction video area 710 occupies a region substantially from the center to the vicinity of upper left periphery of the delete selection screen 700. The reproduction video area 710, based on the reproduction information, displays a motion image reproduced in a normal manner as shown in FIG. 7(A) or a motion image or a still image of an unnecessary scene reproduced in an abstract manner as shown in FIG. 7(B).

The scene attribute area 720 is located to the right of the reproduction video area 710. The scene attribute area 720 displays: scene number information 721 regarding the number of the unnecessary scene being reproduced; an icon 722 based on the icon data 43; characteristic graph information 723 illustrating, as a graph, a characteristic value indicated by the scene attribute information 50; and characteristic character string information 724 for indicating, as a characteristic string, the attribute and the characteristic value indicated by the scene attribute information 50.

A content displayed on the scene attribute area 720 is suitably updated in correspondence with the unnecessary scene displayed in the reproduction video area 710.

The selection manipulation area 730 is located under the reproduction video area 710 and the scene attribute area 720. The selection manipulation area 730 displays: selection message information 731 suggesting to input whether or not to delete the unnecessary scene being reproduced; delete information 732 selected when the unnecessary scene is deleted; non-delete information 733 selected when the unnecessary scene is not deleted and becomes a selection scene; and a cursor 734 that surrounds one of the delete information 732 and the non-delete information 733 selected by the user.

Here, an area R1 of the reproduction video area 710 from a chain line Q1 to a left corner indicates an area affected by backlight. Areas R2 surrounded by two-dotted chain lines Q2 indicate images existing because of affection of camera shake.

Based on the input signal At from the input unit 120, the GUI 154 recognizes input of settings that selection as the selection scene or deletion is to be conducted. Then, the GUI 154 associates selection decision result information that corresponds to the recognized content with the selected unnecessary scene and outputs the associated information to the selection distribution unit 155.

For example, in normal reproduction as shown in FIG. 7(A), if the GUI 154 recognizes that selection as the selection scene is conducted during reproduction of a backlit scene, the GUI 154 outputs selection decision result information telling that this backlit scene is entirely selected as the selection scene. In addition, in abstract reproduction as shown in FIG. 7(B), if the GUI 54 recognizes that a still image of a backlit scene or a camera-shake motion image is to be deleted during reproduction, the GUI 54 outputs the selection decision result information telling that the entire backlit scene or the entire camera shake scene is to be deleted.

As shown in FIGS. 1 and 5, the selection distribution unit 155 is connected to the scene sort unit 160.

The selection distribution unit 155 obtains unnecessary scene data from the storage unit 152 and the selection decision result information associated with the unnecessary scene from the GUI 154. Then, if the selection distribution unit 155 recognizes that a predetermined unnecessary scene is selected as a selection scene, the unnecessary scene data of the selected unnecessary scene is converted into a selection scene signal Ss as selection scene data and outputs the converted selection scene signal Ss to the scene sort unit 160.

Also, if the selection distribution unit 155 recognizes that the unnecessary scene is selected to be deleted, the unnecessary scene data of the unnecessary scene is processed for abandonment.

As shown in FIG. 1, the scene sort unit 160 is connected to the storage 20. In addition, the scene sort unit 160 is connected to the classification distribution unit 147 of the scene classification unit 140 and to the selection distribution unit 155 of the scene selection unit 150.

The scene sort unit 160 suitably obtains the necessary scene signal Sk from the classification distribution unit 147 and the selection scene signal Ss from the selection distribution unit 155. Then, the scene sort unit 160 sorts the necessary scene data of the necessary scene signal Sk and the selection scene data of the selection scene signal Ss in a displaying order to create editing data for reproducing a necessary scene and a selection scene. The editing data is converted into an editing signal Sz and outputted to the storage 20.

Action of Editing Device

Next, as an example of an action of the editing device 100A, creation processing of the editing data will be described below with reference to the drawings.

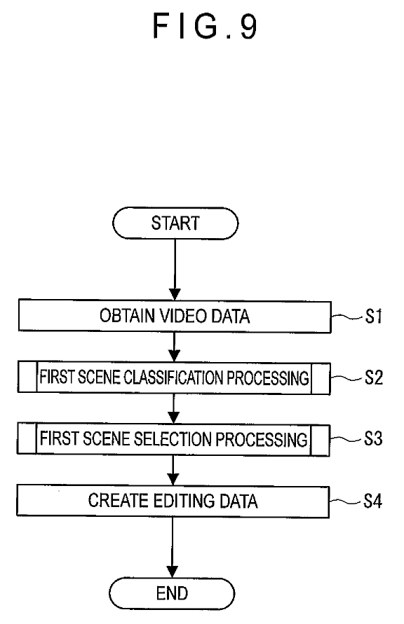

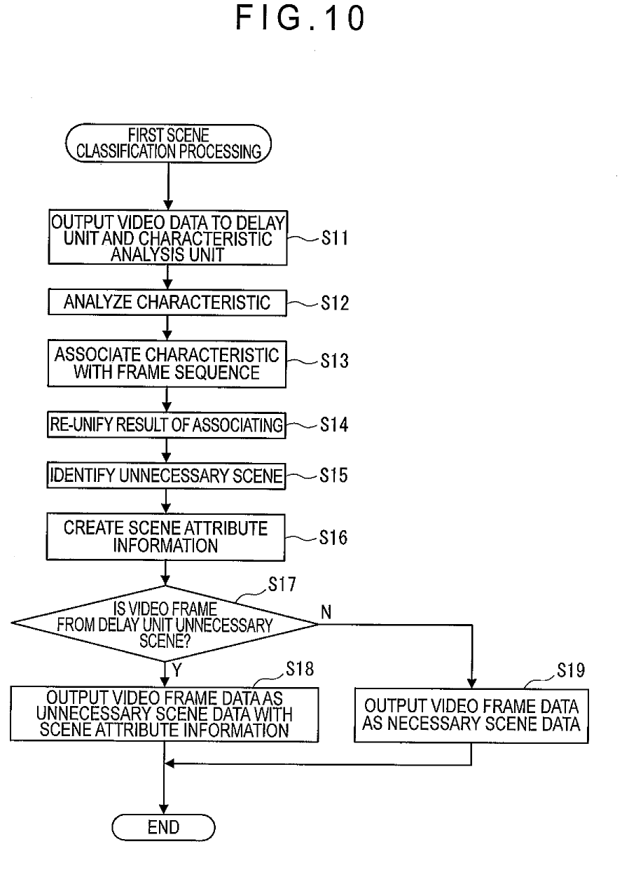

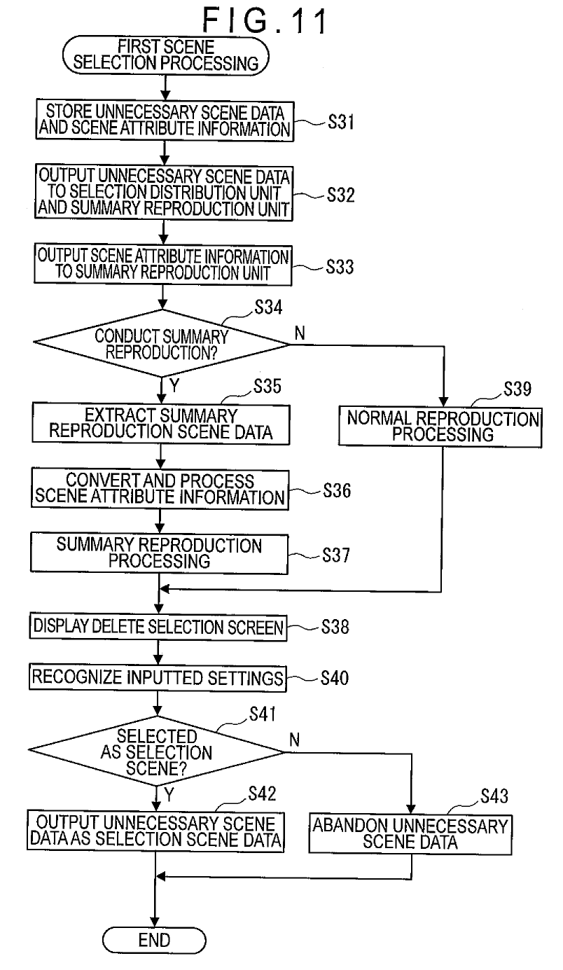

FIG. 9 is a flowchart showing creation processing of the editing data in the first embodiment. FIG. 10 is a flowchart showing first scene classification processing. FIG. 11 is a flowchart showing first scene selection processing.

As shown in FIG. 9, the editing device 100A obtains video data from the video data output unit 10 by the scene classification unit 140 (Step S1). Then, the editing device 100A conducts the first scene classification processing (Step S2), in which the necessary scene data is outputted to the scene sort unit 160 and the unnecessary scene data to the scene selection unit 150.

Subsequently, the editing device 100A conducts the first scene selection processing (Step S3), in which the selection scene data is outputted to the scene sort unit 160 by the scene selection unit 150. The editing data having the necessary scene data and the selection scene data is created by the scene sort unit 160 (Step S4) and stores the created editing data in the storage 20.

As shown in FIG. 10, in the first scene classification processing in Step S2, the scene classification unit 140 outputs the video data to the delay unit 143 and the characteristic analysis unit 144 (Step S11).

For each scene, the characteristic analysis unit 144 analyzes the characteristic of video of the video data (Step S12). Then, the characteristic analysis unit 144 associates the characteristic with the frame sequence of each scene (Step S13) and outputs the associated characteristic to the characteristic unification unit 145.

The characteristic unification unit 145 re-unifies results of associating the characteristics by the characteristic analysis unit 144 (Step S14) and outputs the result to the characteristic comparison unit 146.

If the characteristic comparison unit 146 obtains the result of the re-unification processing from the characteristic unification unit 145, the characteristic comparison unit 146 identifies, based on the characteristic reference value information 31, whether or not each scene is an unnecessary scene (Step S15) and creates identification information. Further, the characteristic comparison unit 146 creates the scene attribute information 50 of this scene recognized to be an unnecessary scene (Step S16) and outputs the identification information to the classification distribution unit 147.

The classification distribution unit 147 decides, based on the identification information, whether or not the video frame of the video frame data obtained from the delay unit 143 is an unnecessary scene (Step S17).

In Step S17, if the scene classification unit 140 decides that a scene is an unnecessary scene, the scene classification unit 140 outputs the video frame data as unnecessary scene data to the scene selection unit 150 together with the scene attribute information 50 (Step S18).

On the other hand, in Step S17, if the scene classification unit 140 decides that a scene is not an unnecessary scene, the scene classification unit 140 outputs the video frame data to the scene sort unit 160 as the necessary scene data (Step S19).

As shown in FIG. 11, in the first scene selection processing in Step S3, the scene selection unit 150 stores the unnecessary scene data and the scene attribute information 50 in the storage unit 152 (Step S31). Then, the scene selection unit 150 outputs the unnecessary scene data to the selection distribution unit 155 and the abstract reproduction unit 153 (Step S32), and the scene attribute information 50 to the abstract reproduction unit 153 (Step S33).

Subsequently, the abstract reproduction unit 153 decides, based on the reproduction state signal from the GUI 154, whether or not the abstract reproduction is conducted (Step S34).

In Step S34, if the abstract reproduction is decided to be conducted, processing in which the still image abstract scene data 71 and the motion image abstract scene data 72 are extracted is conducted as extraction processing of the abstract reproduction scene data (Step S35). In addition, the scene attribute information 50 is converted and processed (Step S36). Then, the scene selection unit 150 conducts abstract reproduction processing (Step S37) and displays the delete selection screen 700 (Step S38).

On the other hand, if, in Step S34, not the abstract reproduction but the normal reproduction is decided to be conducted, the normal reproduction processing is conducted (Step S39) and the processing of Step S38 is conducted.

Subsequently, the GUI 154 recognizes the inputted settings (Step S40) and decides whether or not the unnecessary scene being reproduced is selected as the selection scene (Step S41).

In Step S41, if a scene is decided to be selected as a selection scene, the selection distribution unit 155 outputs the unnecessary scene data of the unnecessary scene to the scene sort unit 160 as the selection scene (Step S42).

On the other hand, if a scene is decided to be deleted in Step S41, the unnecessary scene data is abandoned (Step S43).

### Advantages of First Embodiment

As set forth above, in the first embodiment, the editing device 100A selects, among the video of the video data, a scene which has a characteristic different from a necessary scene that may be decided to be necessary by a user such as a backlit scene or a camera shake scene as an unnecessary scene. Then, the unnecessary scene data that corresponds to the unnecessary scene is selected from the video data, and the display unit 110 displays the unnecessary scene based on the unnecessary scene data.

Accordingly, the editing device 100A allows the user to select necessary scenes and unnecessary scene among the camera shake scenes or the backlit scenes. In addition, for example, if a camera shake scene is present in similar videos that are captured at substantially identical locations, the user can recognize that the camera scene is present without conducting an operation to select a camera shake scene.

Accordingly, the editing device 100A can facilitate editing of the appropriate video data for the user.

In addition, based on the action characteristic of each scene, a scene of high-speed pan or camera shake due to camera work is selected as an unnecessary scene.

Accordingly, the user can recognize unnecessary scene of the high-speed pan or the camera shake, likely to be caused by camera work, thereby improving convenience.

In addition, based on a color characteristic of each scene, a scene of backlight or color seepage is selected as an unnecessary scene.

Accordingly, the user can recognize an unnecessary scene of the backlight or the color seepage, likely to be caused by environment in general, thereby improving convenience.

In addition, based on the characteristic of action or spatial frequency of each scene, a scene in which an obstacle crosses in front of the camera or a scene in which an obstacle is present in a periphery of the video is selected as an unnecessary scene.

Accordingly, the user can recognize an unnecessary scene in which an unexpected obstacle is present, thereby further improving convenience.

In addition, based on a spatial frequency characteristic of each scene, a defocused scene is selected as an unnecessary scene.

Accordingly, the user can recognize an unnecessary defocused scene, which is likely to be caused, thereby further improving convenience.

In addition, if the attribute of the unnecessary scene is recognized to be at least one of the high-speed pan and the camera shake, a portion of the unnecessary scene undergoes abstract reproduction as a motion image.

Accordingly, because a portion of unnecessary scenes of the high-speed pan or the camera shake, an attribute of which cannot be recognized by a user in still image reproduction but can be can be recognized in motion image reproduction, undergoes abstract reproduction in a motion image, the user can recognize a lot of unnecessary scenes in a short period.

In addition, if the attribute of the unnecessary scene is recognized to be at least one of the backlight, the color seepage, and the defocus, a portion of the unnecessary scenes undergoes abstract reproduction in a still image.

Accordingly, because a portion of an unnecessary scene of the backlight, color seepage, obstacle, or defocus, an attribute of which can be recognized by a user in a still image reproduction, undergoes abstract reproduction in a still image, the user can recognize more unnecessary scenes in a short period.

In addition, based on the settings inputted by the user, either normal reproduction in which all of the unnecessary scenes are reproduced or the above-described abstract reproduction is conducted.

Accordingly, the unnecessary scene can be reproduced in a manner corresponding to preference of the user, thereby further improving convenience.

In addition, the scene classification unit 140 of the editing device 100A outputs the necessary scene data to the scene sort unit 160. Also, the scene selection unit 150 outputs the unnecessary scene data selected by the user to the scene sort unit 160 as the selection scene data. Then, the scene sort unit 160 creates the editing data including the necessary scene data and the selection scene data.

Accordingly, the editing device 100A can create the editing data formed by editing the video data according to the preference of the user, thereby further improving convenience.

In addition, based on the characteristic reference value information 31 of the characteristic reference value temporary storage unit 141, it is identified whether or not the predetermined scene is an unnecessary scene.

Accordingly, an unnecessary scene is recognized by simple processing in which it is only required that the characteristic analysis information and the characteristic reference value information 31 are compared. Therefore, processing burden of unnecessary scene identification processing can be reduced.

In addition, the attribute and the characteristic value are concurrently displayed when the unnecessary scene is displayed.

Accordingly, the user can recognize an attribute and a degree of the camera shake, the backlight and the like of the unnecessary scene, thereby allowing the user to suitably choose and discard among unnecessary scenes.

In addition, the attribute of the unnecessary scene is displayed by an icon, and the characteristic value is displayed by a graph.

Accordingly, the user can more easily recognize the attribute or the degree of the unnecessary scene, so that the operational load during editing operation can be reduced.

### Second Embodiment

A second embodiment of the invention will be described below with reference to the drawings.

In the second embodiment, among the unnecessary scenes in the first embodiment, the unnecessary scenes that can be corrected will be referred to as correctable scenes for description. Also, the same arrangements as the first embodiment will be denoted with the same numerals and the same names, and the description thereof will be omitted or simplified.

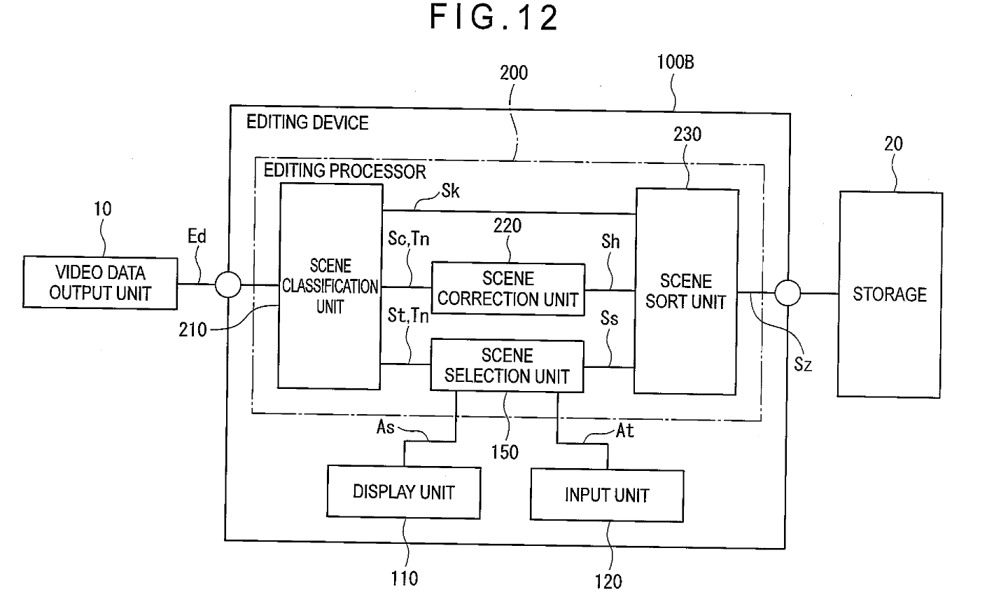

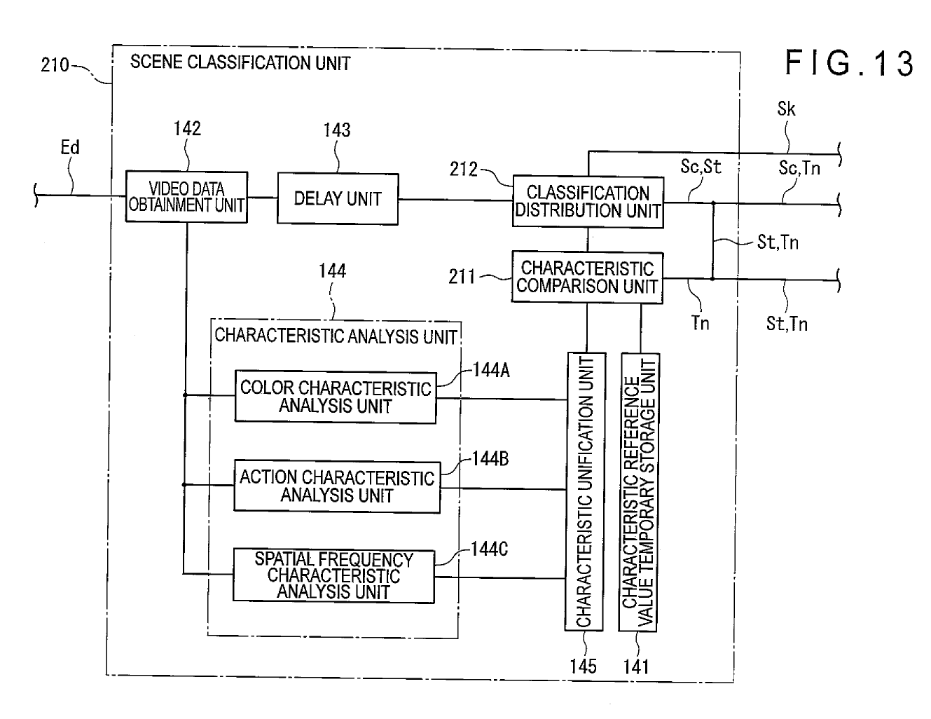

FIG. 12 is a block diagram showing a schematic arrangement of an editing device in the second embodiment. FIG. 13 is a block diagram showing a schematic arrangement of a scene classification unit in the second embodiment and a modification of the second embodiment.

Arrangement of Editing Device

In FIG. 12, 100B denotes an editing device (a data processor). The editing device 100B includes a display unit 110, an input unit 120, and an editing processor 200. The editing processor 200 includes: a scene classification unit 210; a scene correction unit 220; a scene selection unit 150; a scene sort unit 230 as an editing data creation unit.

The scene classification unit 210 is connected to a video data output unit 10, a scene selection unit 150, a scene correction unit 220, and a scene sort unit 230.

The scene classification unit 210 classifies the video data to unnecessary scene data and necessary scene data. Further, the unnecessary scene data that corresponds to the correctable scene is classified as correctable scene data. Then, the unnecessary scene data is outputted to the scene selection unit 150, the correctable scene data is outputted to the scene correction unit 220, and the necessary scene data is outputted to the scene sort unit 230.

Here, the correctable scene data corresponds to the unnecessary scene data of the correctable scene according to the invention, and the unnecessary scene data corresponds to the unnecessary scene data of the uncorrectable scene according to the invention.

As shown in FIG. 13, the scene classification unit 210 has an arrangement similar to the scene classification unit 140 of the first embodiment and includes: a characteristic comparison unit 211 as the identification unit and a classification distribution unit 212 as the selection unit instead of the characteristic comparison unit 146 and the classification distribution unit 147.

The characteristic reference value temporary storage unit 141 stores a characteristic reference value information table 35 as shown in FIG. 3 in a suitably readable manner.

The characteristic reference value information table 35 includes at least one piece of characteristic reference value information 36. The characteristic reference value information 36 is information regarding the standard of a predetermined attribute referred to when a predetermined scene is identified as an unnecessary scene or a correctable scene.

The characteristic reference value information 36 is formed as a piece of data in which characteristic information 37 and characteristic parameter reference information 38 are associated with each other.

The characteristic parameter reference information 38 records parameters that are referred to when an unnecessary scene or a correctable scene is identified. In other words, when a parameter of a predetermined scene is in a first standard range recorded in the characteristic parameter reference information 38, a necessary scene is identified. Alternatively, when a parameter of a scene is out of the first standard range and is within a second standard range that is wider than the first standard range, the scene is identified to be a correctable scene. Furthermore, if a parameter of a scene is out of the second standard range, the scene is identified to be an unnecessary scene.

As shown in FIGS. 12 and 13, the characteristic comparison unit 211 is connected to the classification distribution unit 212, the scene correction unit 220, and the scene selection unit 150.

The characteristic comparison unit 211 obtains the frame sequence information and the characteristic analysis information from the characteristic unification unit 145. Further, if the characteristic comparison unit 211 decides that all the characteristics of the characteristic analysis information that corresponds to a predetermined frame sequence information are within the first standard range of the characteristic parameter reference information 38, the characteristic comparison unit 211 identifies the scene to be a necessary scene. Then, the characteristic comparison unit 211 associates the identification information to the effect with the frame sequence information, and outputs the information to the classification distribution unit 212.

Alternatively, if the characteristic comparison unit 211 decides that at least one of the characteristics of the characteristic analysis information that corresponds to the frame sequence information is out of the first standard range and all the characteristics of the characteristic analysis information that corresponds to the frame sequence information are within the second standard range, the characteristic comparison unit 211 identifies the scene to be a correctable scene. Then, the characteristic comparison unit 211 outputs the identification information to the effect to the classification distribution unit 212. Further, the characteristic comparison unit 211 associates the scene attribute information 50 created based on all the characteristic analysis information decided to be out of the first standard range with the frame sequence information, and converts the associated information into a scene attribute signal Tn to output to the scene correction unit 220.

Alternatively, if the characteristic comparison unit 211 decides that at least one of the characteristics of the characteristic analysis information that corresponds to the frame sequence information is out of the second standard range, the characteristic comparison unit 211 identifies the scene to be an unnecessary scene and outputs identification information to the effect to the classification distribution unit 212. Further, the characteristic comparison unit 211 converts the scene attribute information 50 created based on all the characteristic analysis information decided to be out of the second standard range into a scene attribute signal Tn to output to the scene selection unit 150.

The classification distribution unit 212 is connected to the scene correction unit 220 and the scene selection unit 150.

If the classification distribution unit 212 obtains the frame sequence information and the identification information from the characteristic comparison unit 211 and decides that a predetermined scene is a necessary scene, the classification distribution unit 212 converts the video frame data to a necessary scene signal Sk to output to the scene sort unit 230.

On the other hand, if the classification distribution unit 212 decides that a predetermined scene is an unnecessary scene, the classification distribution unit 212 converts the video frame data into the unnecessary scene signal St as the unnecessary scene data to output to the scene selection unit 150.

Alternatively, if the classification distribution unit 212 decides that a predetermined scene is a correctable scene, the classification distribution unit 212 converts the video frame data into the correctable scene signal Sc as the correctable scene data to output to the scene correction unit 220.

The scene correction unit 220 is connected to the scene sort unit 230.

The scene correction unit 220 obtains the scene attribute signal Tn from the characteristic comparison unit 211 and the correctable scene signal Sc from the classification distribution unit 212. Then, based on the scene attribute information 50 of the scene attribute signal Tn, the correctable scene data of the correctable scene signal Sc is corrected.

Specifically, the scene correction unit 220 conducts correction processing on a characteristic decided to be out of the first standard range of the correctable scene. For example, if the correctable scene is a backlit scene, in other words, if the color characteristic is out of the first standard range, the color characteristic is corrected. Then, the scene correction unit 220 creates correction scene data for displaying the corrected scene as the correction scene and outputs the created data to the scene sort unit 230 as the correction scene signal Sh.

The scene sort unit 230 suitably obtains the necessary scene signal Sk from the classification distribution unit 212, the selection scene signal Ss from the selection distribution unit 155, and the correction scene signal Sh from the scene correction unit 220. Then, the scene sort unit 230 sorts the necessary scene data, the selection scene data, and the correction scene data in the displaying order and creates the editing data for reproducing a necessary scene, a selection scene, and a correction scene. The editing data is converted into an editing signal Sz and outputted to the storage 20.

Action of Editing Device

Next, as an example of an action of the editing device 100B, creation processing of the editing data will be described below with reference to the drawings

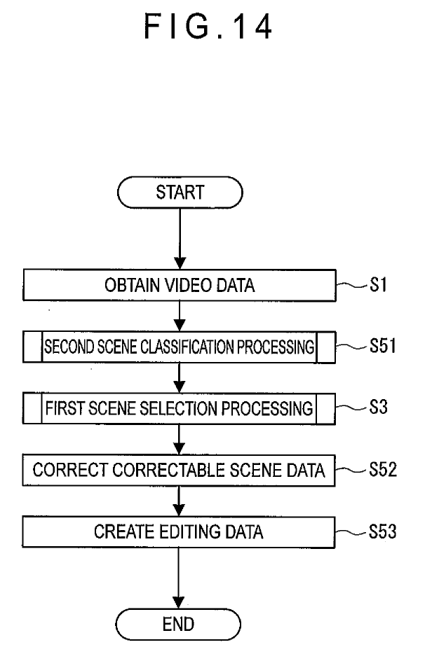

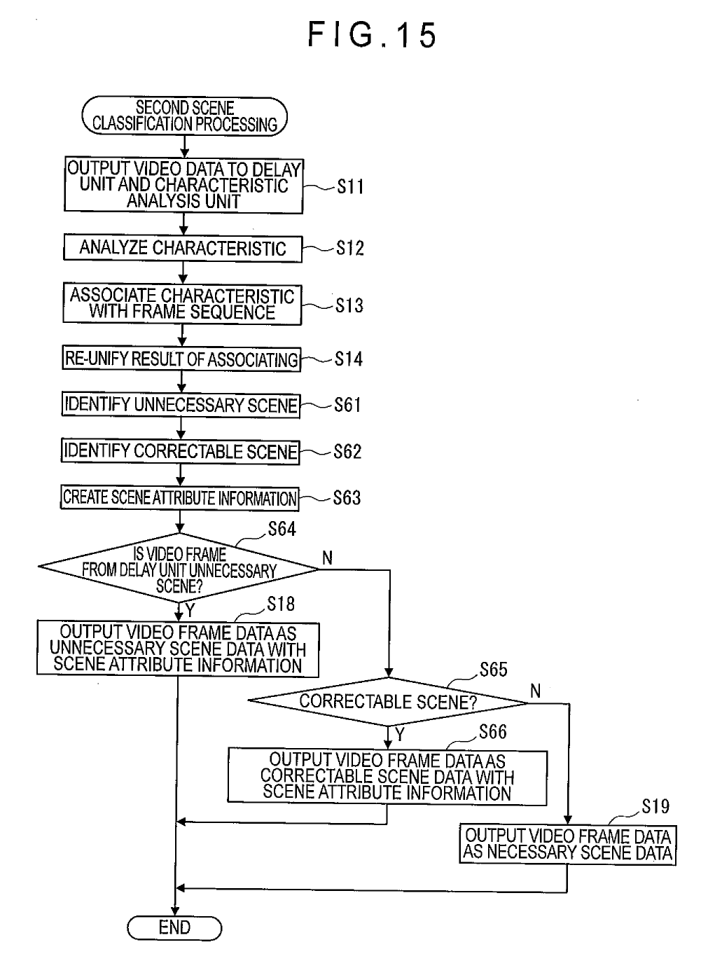

FIG. 14 is a flowchart showing creation processing of the editing data in the second embodiment. FIG. 15 is a flowchart showing second scene classification processing. Note that the same action as the first embodiment is denoted with the same numerals and the description thereof will be omitted.

As shown in FIG. 14, after conducting the processing of Step S1, the editing device 100B conducts the second scene classification processing (Step S51) and outputs the necessary scene data to the scene sort unit 230, the unnecessary scene data to the scene selection unit 150, and the correctable scene data to the scene correction unit 220.

Subsequently, the editing device 100B conducts Step S3 in which the scene correction unit 220 corrects the correctable scene data from the scene classification unit 210 (Step S52) and outputs the correction scene data to the scene sort unit 230. Then, the scene sort unit 230 creates editing data including the necessary scene data, the selection scene data, and the correction data (Step S53) and stores the created editing data in the storage 20.

As shown in FIG. 15, in the second scene classification processing in Step S51, the scene classification unit 210 conducts Steps S11 to S14, and the characteristic comparison unit 211 identifies whether or not each scene is an unnecessary scene (Step S61) to create identification information. Further, the characteristic comparison unit 211 identifies whether or not the scene identified not to be an unnecessary scene is a correctable scene (Step S62) to create identification information.

Then, the characteristic comparison unit 211 creates scene attribute information 50 of a scene identified to be an unnecessary scene or a correctable scene (Step S63) and outputs the created information to the classification distribution unit 212 together with the identification information.

The classification distribution unit 212 decides whether or not the video frame is an unnecessary scene (Step S64). If the scene classification unit 140 decides that a scene is an unnecessary scene in Step S64, the scene classification unit 140 conducts the processing of Step S18, that is, the processing in which the unnecessary scene data or the like is outputted to the scene selection unit 150.

On the other hand, if the scene classification unit 140 decides that a scene is not an unnecessary scene in Step S64, the scene classification unit 140 decides whether or not the scene is a correctable scene (Step S65). Then, if the scene classification unit 140 decides that a scene is a correctable scene in Step S65, the scene classification unit 140 outputs the correctable scene data to the scene correction unit 220 together with the scene attribute information 50 (Step S66).

In Step S65, if the scene classification unit 140 decides that a scene is not a correctable scene, the processing of Step S20 is conducted.

### Advantages of Second Embodiment

In the second embodiment as set forth above, the following advantages can be obtained in addition to the advantages of the first embodiment.

The editing device 100B selects unnecessary scene data, correctable scene data, and necessary scene data from video of video data. In addition, the editing device 100B corrects the correctable scene data to create the correction scene data. Then, the editing device 100B creates editing data including the necessary scene data, the selection scene data, and the correction scene data.

Accordingly, for example, if a state of a backlit scene allows correction, the scene can be processed as a correction scene in which the backlit state is corrected instead of being reproduced as an unnecessary scene. Therefore, the number of scenes displayed as unnecessary scenes can be reduced, thereby reducing the operational burden on the user.

In addition, when the scene correction unit 220 corrects the correctable scene data, the scene correction unit 220 conducts processing based on the scene attribute information 50 that corresponds to the correction scene data.

Accordingly, appropriate correction processing in correspondence with the content recorded in the scene attribute information 50, in other words, in correspondence with a state such as a backlit state of the actual scene, can be conducted. Therefore, the editing data including an appropriately corrected correction scene can be created.

### Third Embodiment

Next, a third embodiment of the invention will be described below with reference to the drawings.

Note that the same arrangements as the first and second embodiments will be denoted with the same numerals and the same names, and the description thereof will be omitted or simplified.

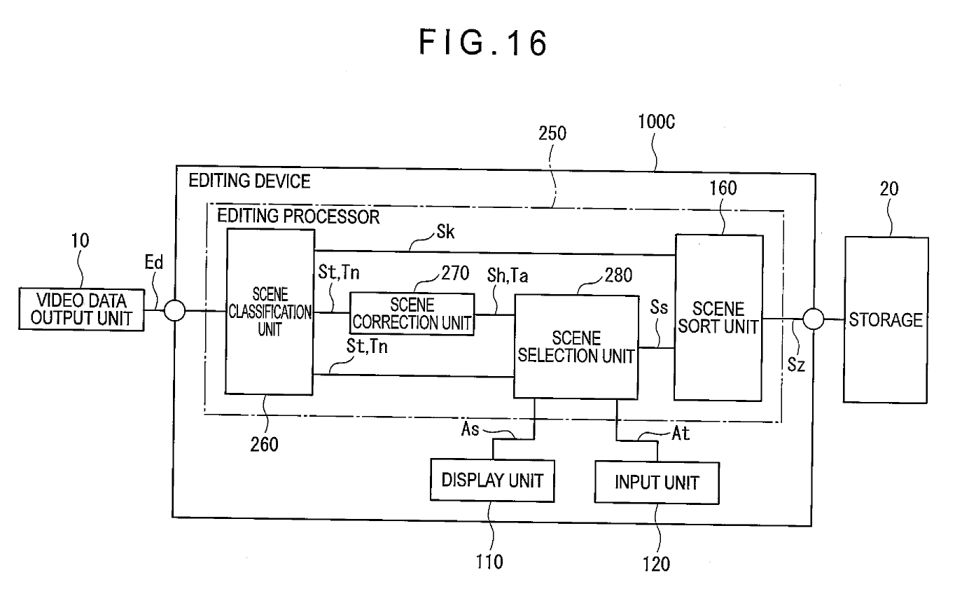

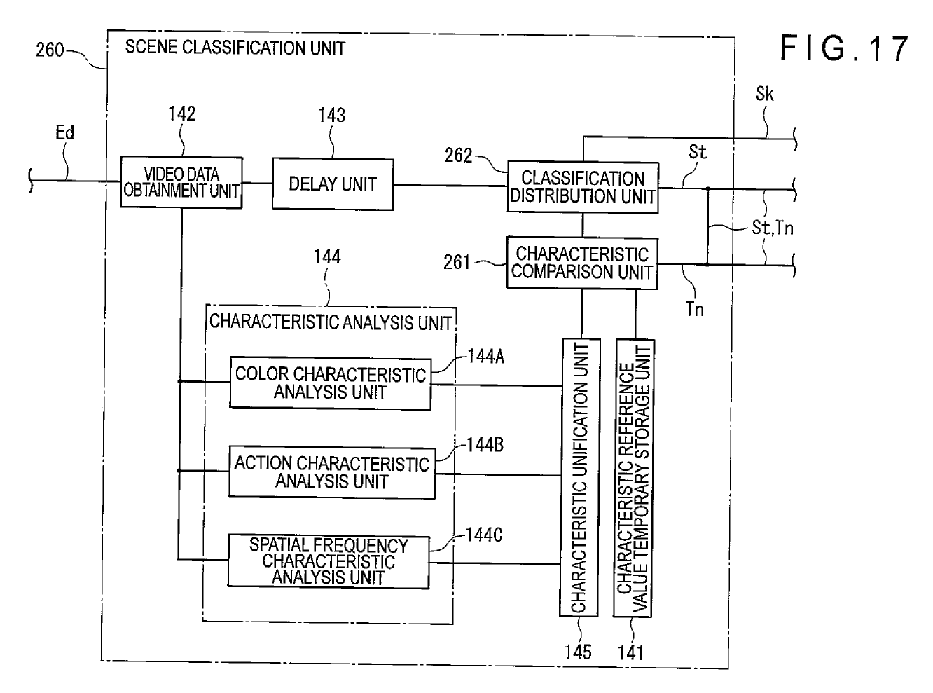

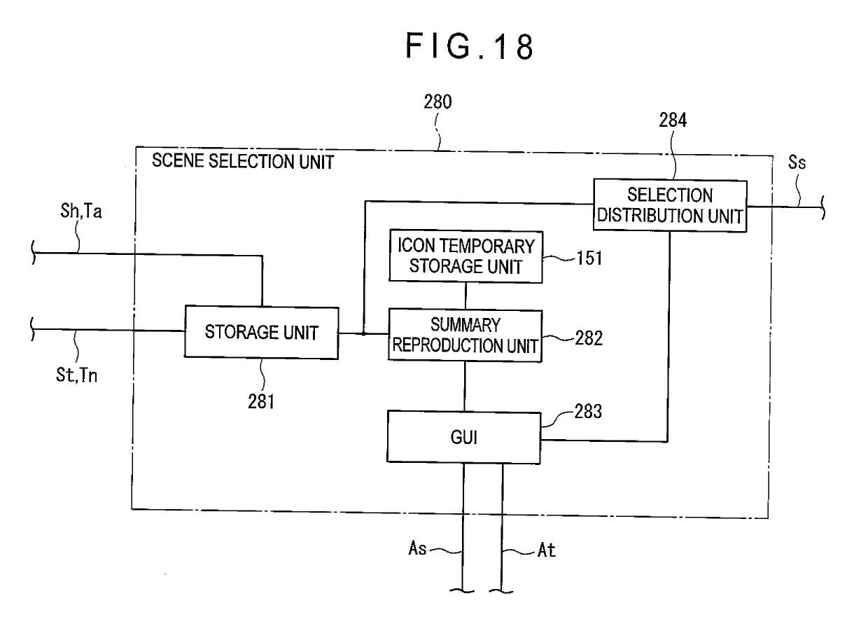

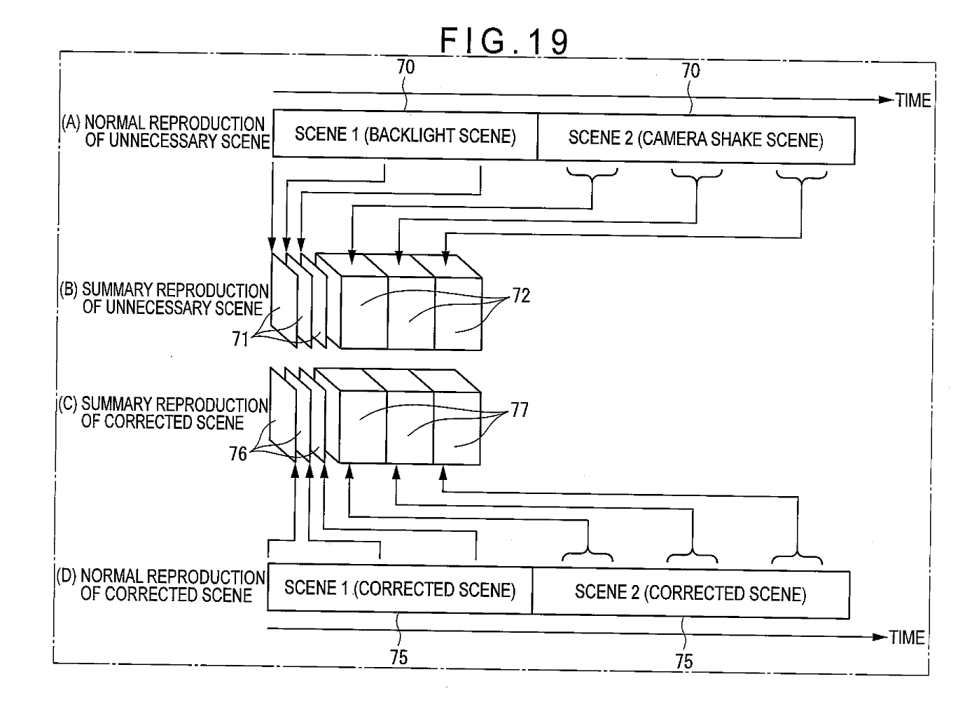

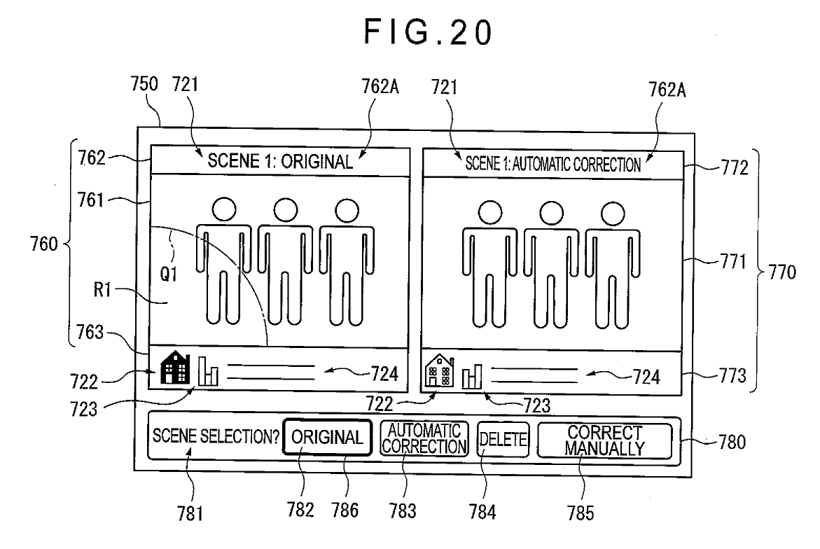

FIG. 16 is a block diagram showing a schematic arrangement of an editing device in the third embodiment. FIG. 17 is a block diagram showing a schematic arrangement of a scene classification unit in the third embodiment and a modification of the third embodiment. FIG. 18 is a block diagram showing a schematic arrangement of a scene selection unit in the third embodiment. FIG. 19 is a timing chart showing actions during normal reproduction processing and abstract reproduction processing of an unnecessary scene and a correction scene in the third embodiment, where a portion (A) shows the action during the normal reproduction processing of the unnecessary scene, a portion (B) shows the action during the abstract reproduction processing of the unnecessary scene, a portion (C) shows the action during the abstract reproduction processing of the correction scene, and a portion (D) shows the action during the normal reproduction processing of the correction scene. FIG. 20 is a schematic diagram showing a schematic arrangement of a delete selection screen in the third embodiment.

Arrangement of Editing Device

In FIG. 16, 100C denotes an editing device (a data processor). The editing device 100C includes a display unit 110, an input unit 120, and an editing processor 250. The editing processor 250 includes: a scene classification unit 260; a scene correction unit 270; a scene selection unit 280; and a scene sort unit 160.

The scene classification unit 260 is connected to a video data output unit 10, a scene correction unit 270, a scene selection unit 280, and a scene sort unit 160.

The scene classification unit 260 classifies the video data to unnecessary scene data and necessary scene data and output the data.

As shown in FIG. 17, the scene classification unit 260 has an arrangement similar to the scene classification unit 140 of the first embodiment and includes a characteristic comparison unit 261 as the identification unit and a classification distribution unit 262 as the selection unit instead of the characteristic comparison unit 146 and the classification distribution unit 147.

The characteristic reference value temporary storage unit 141 stores a characteristic reference value information table 30 as shown in FIG. 3 in a suitably readable manner.

As shown in FIGS. 16 and 17, the characteristic comparison unit 261 is connected to the classification distribution unit 262, the scene correction unit 270, and the scene selection unit 280.

The characteristic comparison unit 261 obtains the frame sequence information and the characteristic analysis information from the characteristic unification unit 145. Further, if the characteristic comparison unit 211 decides that all the characteristics of the characteristic analysis information that corresponds to predetermined frame sequence information are within the standard range of the characteristic parameter reference information 33, the characteristic comparison unit 211 identifies the scene to be a necessary scene. Then, the characteristic comparison unit 211 associates the identification information to the effect with the frame sequence information, and outputs the information to the classification distribution unit 262.

Alternatively, if the characteristic comparison unit 261 decides that at least one of the characteristics of the characteristic analysis information that corresponds to the frame sequence information is out of the standard range, the characteristic comparison unit 261 identifies the scene to be an unnecessary scene and outputs identification information to the effect to the classification distribution unit 262. Further, the characteristic comparison unit 261 converts the scene attribute information 50 that corresponds to this unnecessary scene into a scene attribute signal Tn to output to the scene correction unit 270 and the scene selection unit 280.

The classification distribution unit 262 is connected to the scene sort unit 160, the scene correction unit 270, and the scene selection unit 280.

If the classification distribution unit 262 obtains the frame sequence information and the identification information from the characteristic comparison unit 261 and decides that a predetermined scene is a necessary scene, the classification distribution unit 262 converts the video frame data into a necessary scene signal Sk as necessary scene data to output to the scene sort unit 160.

On the other hand, if the classification distribution unit 262 decides that a predetermined scene is an unnecessary scene, the classification distribution unit 262 converts the video frame data into an unnecessary scene signal St as unnecessary scene data to output to the scene correction unit 270 and the scene selection unit 280.

The scene correction unit 270 is connected to the scene selection unit 280.

The scene correction unit 270 obtains the scene attribute signal Tn from the characteristic comparison unit 261 and the unnecessary scene signal St from the classification distribution unit 262. Further, based on the scene attribute information 50 of the scene attribute signal Tn, the unnecessary scene data of the unnecessary scene signal St is corrected to create correction scene data. Then, the scene correction unit 270 outputs this correction scene data to the scene selection unit 280 as the correction scene signal Sh.

Further, the scene correction unit 270 creates correction scene attribute information by updating a content of the scene attribute information 50 to a corrected state and outputs the created information to the scene selection unit 280 as the correction scene attribute signal Ta.

The scene selection unit 280 displays the unnecessary scene data and the correction scene data on the display unit 110 and outputs the unnecessary scene data or the correction scene data selected by the user as data not to be deleted to the scene sort unit 160 as selection scene data.

As shown in FIG. 18, the scene selection unit 280 includes an icon temporary storage unit 151, a storage unit 281, an abstract reproduction unit 282 as a display control unit, a GUI 283 as a display control unit and a necessity deciding unit, and a selection distribution unit 284.

The storage unit 281 is connected to an abstract reproduction unit 282, a selection distribution unit 284, a characteristic comparison unit 261 of a scene classification unit 260, a classification distribution unit 262, and a scene correction unit 270.

The storage unit 281 stores scene attribute information 50 of a scene attribute signal Tn from the characteristic comparison unit 261 and correction scene attribute information of a correction scene attribute signal Ta from the scene correction unit 270 to suitably output to the abstract reproduction unit 282.

The storage unit 281 stores the unnecessary scene data from the classification distribution unit 262 and the correction scene data of a correction scene signal Sh from the scene correction unit 270 to suitably output to the abstract reproduction unit 282 and the selection distribution unit 284.

The abstract reproduction unit 282 obtains a reproduction state signal and conducts reproduction processing based on the reproduction state signal.

Specifically, when conducting normal reproduction processing, the abstract reproduction unit 282 controls all the unnecessary scenes and the correction scenes to be reproduced as motion images.

For example, as shown in FIG. 19(A), the abstract reproduction unit 282 conducts the processing similar to the first embodiment as shown in FIG. 7(A) and outputs reproduction information in which all the unnecessary scenes are reproduced as motion images to the GUI 283.

In addition, as shown in FIG. 19(D), the abstract reproduction unit 282, based on two correction scene data groups 75 that correspond to the motion images formed by correcting the scene 1 and the scene 2 of FIG. 19(A), reproduces all the correction scenes as motion images to output as reproduction information.

Further, the abstract reproduction unit 282 obtains the scene attribute information 50 and the correction scene attribute information from the storage unit 281, extracts the icon data 43 from the icon temporary storage unit 151, and converts and processes these into a state for displaying the delete selection screen 750 to output to the GUI 283. At this time, the displaying fashion of the icon data 43 is set to be different in, for example, tone or brightness, between the unnecessary and the correction scenes.

On the other hand, if the abstract reproduction unit 282 conducts the abstract reproduction processing, the abstract reproduction unit 282 controls a portion of the unnecessary scene and the correction scene as a motion image or a still image.

Specifically, as shown in FIG. 19(B), based on attribute of an unnecessary scene based on the attribute information 51 of the scene attribute information 50, the abstract reproduction unit 282 conducts the processing similar to the first embodiment as shown in FIG. 7(B) and outputs reproduction information in which, for example, a backlit scene is reproduced as a still image based on the still image abstract scene data 71, or a camera shake scene is reproduced as a motion image based on the motion image abstract scene data 72.

In addition, as shown in FIG. 19(C), the abstract reproduction unit 282 extracts correction scene data formed by correcting the still image abstract scene data 71 as correction still image abstract scene data 76 and correction scene data formed by correcting motion image abstract scene data 72 as correction motion image abstract scene data 77 from the correction scene data group 75. Then, the abstract reproduction unit 282 outputs reproduction information in which the backlit scene and the camera shake scene are reproduced as still images and motion images based on these scenes.

Further, the abstract reproduction unit 282 extracts, converts, processes, and outputs the scene attribute information 50, the correction scene attribute information, and the icon data 43 corresponding to the unnecessary scene data and the correction scene data that undergo abstract reproduction.

The GUI 283 recognizes inputted setting that tells to conduct normal reproduction or abstract reproduction of an unnecessary scene and a correction scene to output a reproduction state signal to the abstract reproduction unit 282.

If the GUI 283 obtains the reproduction information, the scene attribute information 50, the correction scene attribute information, and the icon data 43 from the abstract reproduction unit 282, the GUI 283 outputs, based on the obtained information, image signals As for displaying the delete selection screen 750 as shown in FIG. 20 to the display unit 110.

Here, the delete selection screen 750 includes the unnecessary scene area 760, the correction scene area 770, and the selection manipulation area 780.

The unnecessary scene area 760 occupies a left region of the delete selection screen 750. The unnecessary scene area 760 displays a variety of videos and information regarding the unnecessary scene.

The unnecessary scene area 760 includes: a reproduction display area 761 provided substantially in the middle with respect to the up-down direction; a scene identification area 762 provided over the reproduction display area 761; and a scene attribute area 763 provided under the reproduction display area 761.

The reproduction display area 761 displays the unnecessary scene in normal reproduction or abstract reproduction as shown in FIGS. 19(A) and (B). The scene identification area 762 displays: scene number information 721; and correction state information 762A regarding whether or not motion images or the like of the reproduction display area 761 have been corrected. The scene attribute area 763 displays an icon 722, characteristic graph information 723, and characteristic character string information 724.

The correction scene area 770 is located to the right of the unnecessary scene area 760. The correction scene area 770 includes: a reproduction display area 771 provided in a manner similar to and displaying information or the like similar to the reproduction display area 761, the scene identification area 762, and the scene attribute area 763 of the unnecessary scene area 760; a scene identification area 772; and a scene attribute area 773.

Here, the unnecessary scene area 760 displays an image in which an area R1 affected by backlight is present. The correction scene area 770 displays an image in which the area R1 is absent since influence of backlight is canceled.

A selection manipulation area 780 is located under the unnecessary scene area 760 and the correction scene area 770. The selection manipulation area 780 displays: selection message information 781 suggesting to input settings such as whether or not to select the unnecessary scene or the correction scene being reproduced as a selection scene; original selection information 782 selected when the unnecessary scene becomes the selection scene; automatic correction selection information 783 selected when the correction scene becomes the selection scene; delete information 784 selected when the unnecessary scene and the correction scene are deleted; manual correction selection information 785 selected when the unnecessary scene or the like is manually corrected; and a cursor 786 which surrounds one piece of the above information selected by the user.

Then, the GUI 283 recognizes the inputted settings based on input signals At from the input unit 120, and associates selection decision result information that corresponds to the content of the inputted settings with the unnecessary scene, correction scene, or the like that are selected to output to the selection distribution unit 284.

For example, the GUI 283 outputs the selection decision result information telling that an unnecessary scene or a correction scene is selected as a selection scene, that both of these scenes are deleted, and that manual correction is conducted.

As shown in FIGS. 16 and 18, the selection distribution unit 284 is connected to the scene sort unit 160.

The selection distribution unit 284 obtains unnecessary scene data and correction scene data from the storage unit 281 and the selection decision result information associated with the unnecessary scene and the correction scene from the GUI 283. Then, if the selection distribution unit 284 recognizes that a predetermined unnecessary scene or a correction scene is selected as the selection scene, the unnecessary scene data or the correction scene data of the selected scene is converted into a selection scene signal Ss as selection scene data to output to the scene sort unit 160.

Also, if the selection distribution unit 284 recognizes that the unnecessary scene and the correction scene are selected to be deleted, the corresponding unnecessary scene data and the correction scene data are processed for abandonment.

Action of Editing Device

Next, creation processing of the editing data as an example of an action of the editing device 100C will be described below with reference to the drawings.

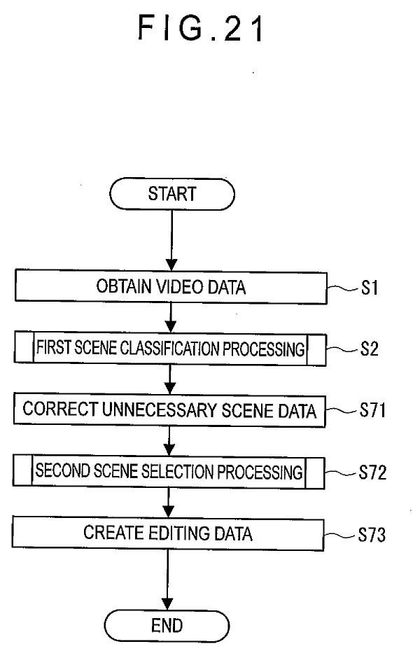

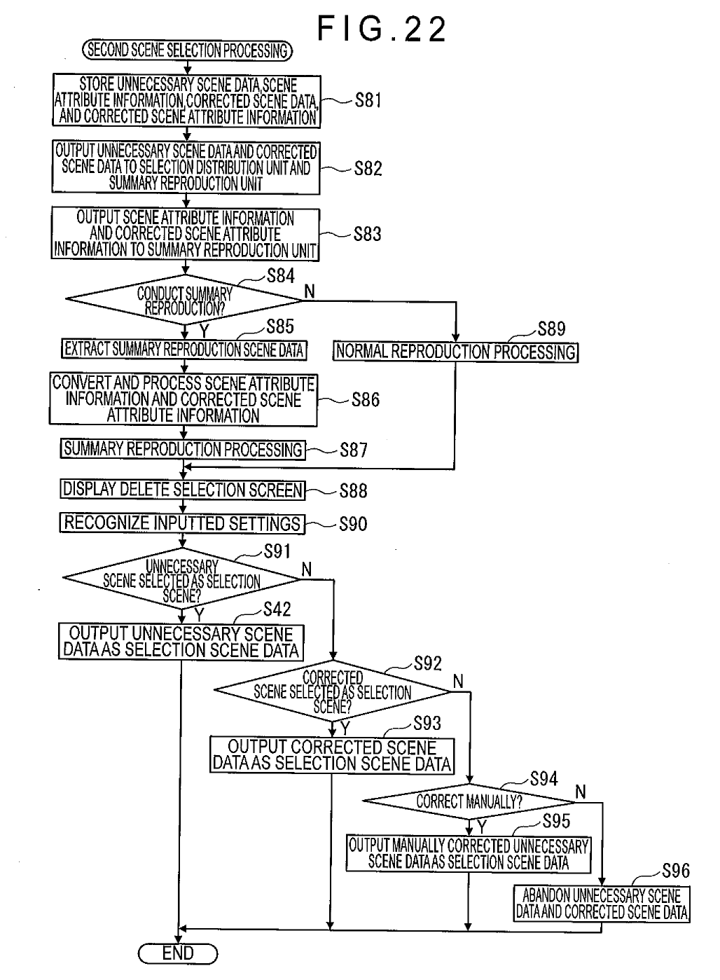

FIG. 21 is a flowchart showing creation processing of the editing data in the third embodiment. FIG. 22 is a flowchart showing second scene selection processing.

Note that the same action as the above-described embodiments is denoted with the same numerals and the description thereof will be omitted.

Incidentally, as shown in FIG. 21, the editing device 100C obtains video data in Step S1, and conducts first classification processing in Step S2.

Subsequently, the editing device 100C corrects unnecessary scene data from the scene classification unit 260 in the scene correction unit 270 (Step S71) and outputs the correction scene data and the like to the scene selection unit 280. Further, the scene selection unit 280 conducts second scene selection processing (Step S72) and outputs the selection scene data to the scene sort unit 160. The scene sort unit 160 creates the editing data (Step S73), and the storage 20 stores the created editing data.

As shown in FIG. 22, in the second scene selection processing in Step S72, the scene selection unit 280 stores the unnecessary scene data, the scene attribute information 50, the correction scene data, and the correction scene attribute information (Step S81). Then, the unnecessary scene data and the correction scene data are outputted to the selection distribution unit 284 and the abstract reproduction unit 282 (Step S82), and the scene attribute information 50 and the correction scene attribute information are outputted to the abstract reproduction unit 282 (Step S83).

Subsequently, the abstract reproduction unit 282 decides, based on the reproduction state signal from the GUI 283, whether or not the abstract reproduction is to be conducted (Step S84).

In Step S84, if the abstract reproduction is decided to be conducted, extraction processing of the abstract reproduction scene data is conducted (Step S85), and the scene attribute information 50 and the correction scene attribute information are converted and processed (Step S86). Then, the scene selection unit 280 conducts abstract reproduction processing (Step S87) and displays the delete selection screen 750 (Step S88).

On the other hand, if, in Step S84, not the abstract reproduction but the normal reproduction is decided to be conducted, the normal reproduction processing is conducted (Step S89) and the processing of Step S88 is conducted.

Subsequently, the GUI 283 recognizes the inputted settings (Step S90) and decides whether or not an unnecessary scene is selected as a selection scene (Step S91).

If it is decided that an unnecessary scene has been selected in Step S91, the processing of Step S42 is conducted, in other words, the unnecessary scene data is outputted to the scene sort unit 160 as selection scene data.

On the other hand, if it is decided that the unnecessary scene has not to been selected in Step 91, it is decided whether or not a correction scene is selected as a selection scene (Step S92).

If it is decided that a correction scene has been selected in Step S92, correction scene data is outputted as the selection scene data (Step S93).

If it is decided that a correction scene has not been selected in Step S92, it is decided whether or not to conduct manual correction (Step S94).

If it is decided that the manual correction is to be conducted in Step S94, manually corrected unnecessary scene data is to be outputted as the selection scene data (Step S95).

On the other hand, if it is decided that the manual correction is not to be conducted in Step S94, the unnecessary scene data and the correction scene data are abandoned (Step S96).

### Advantages of Third Embodiment

In the third embodiment as set forth above, the following advantages can be obtained in addition to the advantages of the first and second embodiments.

The editing device 100C selects unnecessary scene data and necessary scene data from video of the video data. In addition, the editing device 100C corrects the unnecessary scene data to create correction scene data. Then, the editing device 100C conducts abstract reproduction or normal reproduction of the unnecessary scene and the correction scene formed by correcting the unnecessary scene.

With the above arrangement, a user can compare the unnecessary scene and the correction scene to make an appropriate choice.

In other words, the user can select the correction scene if the correction effect matches preference of the user, and the user can suitably select the unnecessary scene if the correction fails to yield a favorable effect and does not match the preference of the user.

Accordingly, a more suitable choice can be made as compared with the arrangements of the first and second embodiments in which only the unnecessary scene undergoes abstract reproduction.

In addition, by comparing the unnecessary scene and the correction scene, the user can intuitively grasp attribute such as camera shake or backlight and the degrees of the attribute.

Furthermore, the user can grasp the meaning of the icon 722 displayed on the delete selection screen 750.

The scene classification unit 260 selects the unnecessary scene data and the necessary scene data from the video data. Then, the editing data including the necessary scene data and selection scene data that is the unnecessary scene data or correction scene data is created.

Accordingly, advantages similar to that of the second embodiment in which the editing data including the correction scene data can be created can be obtained. In addition, as compared with the second embodiment in which the unnecessary scene, the correctable scene, and the necessary scene are classified, processing burden of the scene classification unit 260 can be reduced, and the arrangement of the scene classification unit 260 can be simplified.

### Fourth Embodiment

Next, a fourth embodiment of the invention will be described with reference to the drawings.

Note that the same arrangements as the first to third embodiments will be denoted with the same numerals and the same names, and the description thereof will be omitted or simplified.

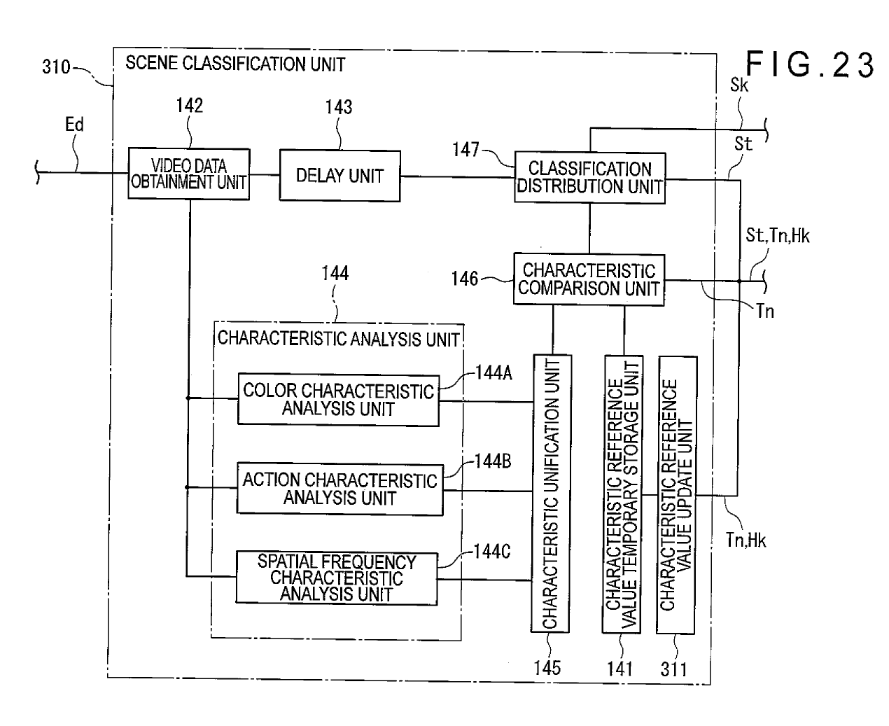

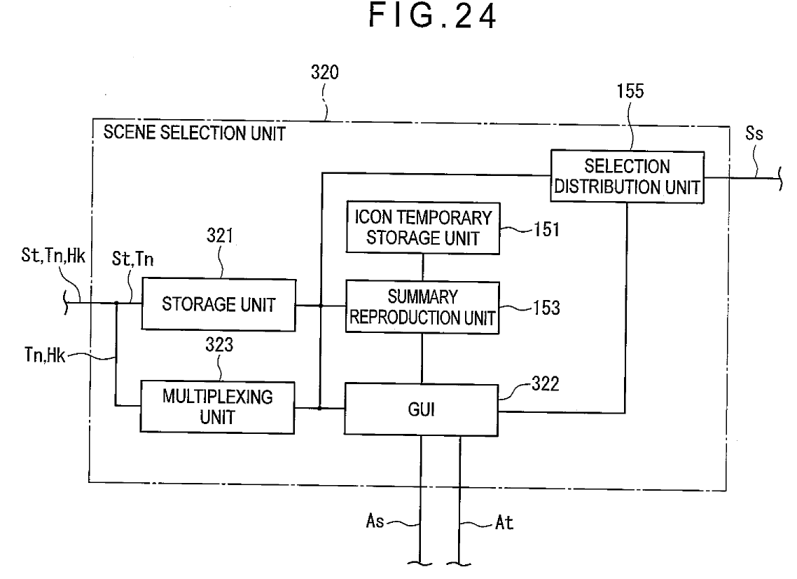

FIG. 23 is a block diagram showing a schematic arrangement of a scene classification unit in the fourth embodiment. FIG. 24 is a block diagram showing a schematic arrangement of a scene selection unit in the fourth embodiment.

Arrangement of Editing Device

In FIG. 1, an editing device 100D is a data processor. The editing device 100D includes a display unit 110, an input unit 120, and an editing processor 300. The editing processor 300 includes a scene classification unit 310, a scene selection unit 320, and a scene sort unit 160.

The scene classification unit 310 classifies the video data to unnecessary scene data and necessary scene data, and outputs the data. In addition, the scene classification unit 310 suitably changes an identification standard of the unnecessary scene based on the result of the selection of the unnecessary scene data by the user.

Then, as shown in FIG. 23, the scene classification unit 310 includes a characteristic reference value update unit 311 as a reference information update unit in addition to an arrangement similar to the scene classification unit 140 of the first embodiment.

As shown in FIGS. 1 and 23, the characteristic reference value update unit 311 is connected to the scene selection unit 320 and the characteristic reference value temporary storage unit 141.

The characteristic reference value update unit 311 includes a non-selection counter and a selection counter (not shown). The non-selection counter and the selection counter are provided respectively corresponding to the characteristics of the characteristic information 32 as shown in FIG. 3.

The characteristic reference value update unit 311 conducts update processing of the characteristic reference value information 31 of the characteristic reference value temporary storage unit 141.

Specifically, the characteristic reference value update unit 311 obtains the scene attribute information 50 outputted from the scene selection unit 320 as the scene attribute signal Tn and the selection decision result information outputted as a selection decision result signal Hk.

Then, if it is recorded that the unnecessary scene data is not selected as a selection scene, in other words, if it is recorded that the unnecessary scene data is abandoned in the selection decision result information, the characteristic that corresponds to the unnecessary scene data is recognized based on the scene attribute information 50. Further, the non-selection counter that corresponds to the recognized characteristic is counted up by one.

For example, if unnecessary scene data whose attribute includes backlight and camera shake is abandoned, the non-selection counter for action characteristics such as color characteristic such as luminance distribution and camera work vibration information that are related to the backlight attribute and the camera shake attribute is counted up.

Further, if it is recognized that the count value of the non-selection counter (which will be referred to as a non-selection count value below) is equal to or greater than a predetermined value, for example, 5 or greater, the characteristic parameter reference information 33 of the characteristic that corresponds to the non-selection count value (which is luminance distribution and camera work vibration information in this case) is updated to a state that narrows the standard range.

In addition, if it is recorded that the unnecessary scene data is selected as the selection scene in the selection decision result information, the characteristic reference value update unit 311 counts up the selection counter that corresponds to the characteristic of the unnecessary scene data by one. Further, if it is recognized that the count value of the selection counter (which will be referred to as a selection count value below) is equal to or greater than a predetermined value, for example, 5 or greater, the characteristic parameter reference information 33 of the characteristic that corresponds to the selection count value is updated to a state that widens the standard range.

The scene selection unit 320 displays unnecessary scene data, suitably outputs the unnecessary scene data to the scene sort unit 160 as the selection scene data, and outputs selection decision result information that corresponds to the unnecessary scene data to the scene classification unit 310.

As shown in FIG. 24, the scene selection unit 320 includes an icon temporary storage unit 151, a storage unit 321, an abstract reproduction unit 153, a GUI 322 as a display control unit and a necessity deciding unit, a selection distribution unit 155, and a multiplexing unit 323.

The storage unit 321 is connected to the abstract reproduction unit 153, the selection distribution unit 155, and the multiplexing unit 323 and conducts processing in which the scene attribute information 50 is outputted to the multiplexing unit 323 in addition to the processing similar to that of the storage unit 152 of the first embodiment.

The GUI 322 is connected to the display unit 110, the input unit 120, the selection distribution unit 155, and the multiplexing unit 323 and conducts processing in which the selection decision result information is outputted to the multiplexing unit 323 in addition to the processing similar to that of the GUI 154 of the first embodiment.

The multiplexing unit 323 is connected to the characteristic reference value update unit 311 of the scene classification unit 310.

The multiplexing unit 323 obtains scene attribute information 50 from the storage unit 321 and the selection decision result information from the GUI 322. Then, a scene attribute signal Tn of the scene attribute information 50 and a selection decision result signal Hk of the selection decision result information are multiplexed and outputted to the characteristic reference value update unit 311.

Action of Editing Device

Next, creation processing of the editing data as an example of an action of the editing device 100D will be described with reference to the drawings.

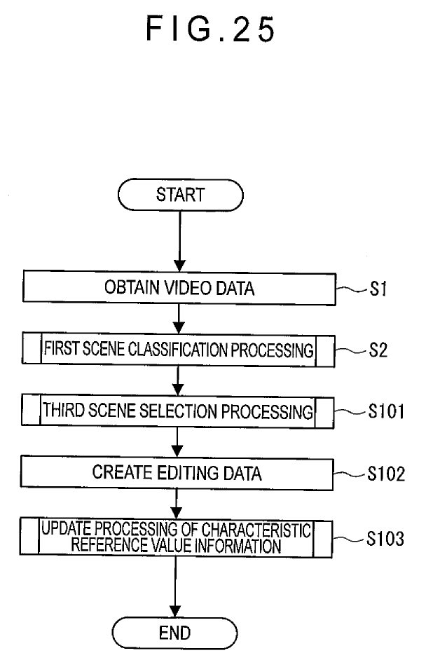

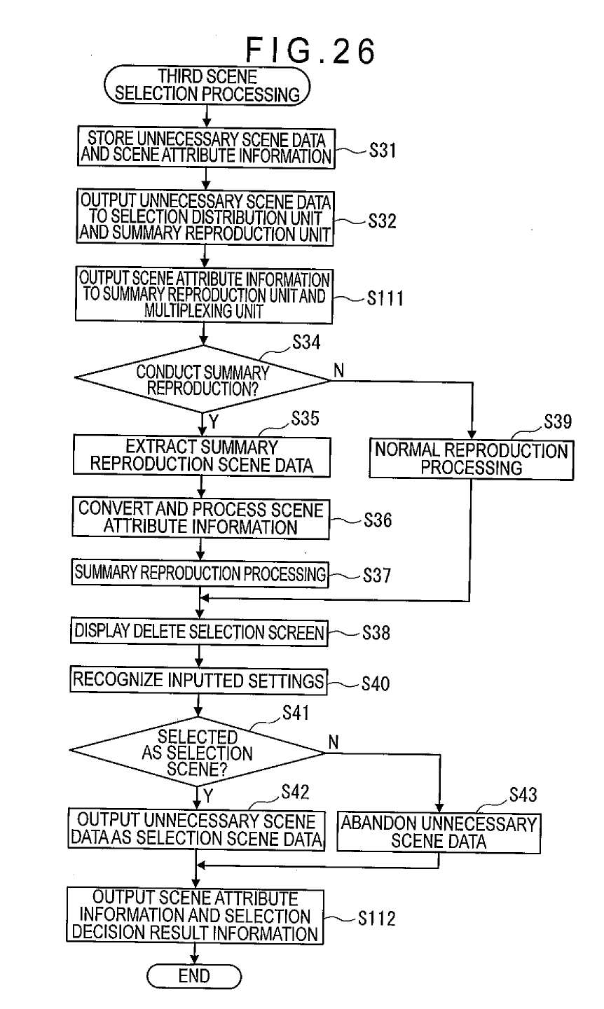

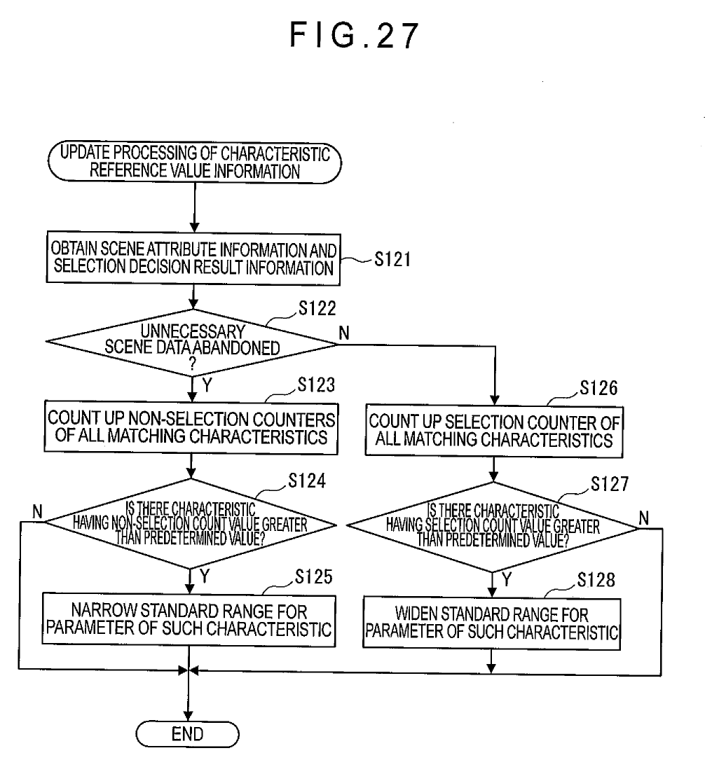

FIG. 25 is a flowchart showing creation processing of the editing data in the fourth embodiment. FIG. 26 is a flowchart showing third scene selection processing. FIG. 27 is a flowchart showing update processing of characteristic reference value information.

Note that the same action as the above-described embodiments is denoted with the same numerals and the description thereof will be omitted.

As shown in FIG. 25, after conducting Steps S1 and S2, the editing device 100D conducts third scene selection processing (Step S101).

Subsequently, the editing device 100D creates the editing data including the selection scene data selected in the third scene selection unit (Step S102) and conducts update processing of the characteristic reference value information 31 (Step S103).

As shown in FIG. 26, in the third scene selection processing of Step S101, after processing of Steps S31 and S32 is conducted, the scene attribute information 50 is outputted to the abstract reproduction unit 153 and the multiplexing unit 323 (Step S11) and processing of Steps S34 to S43 are suitably conducted. Then, after processing of Steps S42 and Step S43 are conducted, the scene attribute information 50 and the selection decision result information that correspond to the result of conducted processing are outputted (Step S112).

Also, in update processing of the characteristic reference value information 31 of Step S103, as shown in FIG. 27, the characteristic reference value update unit 311 obtains the scene attribute information 50 and the selection decision result information (Step S121) and decides whether or not the unnecessary scene data is abandoned (Step S122).

If the characteristic reference value update unit 311 decides that the unnecessary scene data is abandoned in Step S122, non-selection counters of all the characteristics that match the unnecessary scene data are counted up (Step S123) and decides whether or not a characteristic whose non-selection count value is equal to or greater than a predetermined value exists (Step S124).

Then, if such a characteristic is decided to exist in Step S124, characteristic parameter reference information 33 is updated in a manner that a standard range of a parameter corresponding to the matching characteristic is narrowed (Step S125), and the processing is finished. On the other hand, in Step S124, if such a characteristic is decided not to exist, the processing is finished.

If the characteristic reference value update unit 311 decides that the unnecessary scene data is not abandoned in Step S122, selection counters of all the characteristics that match the unnecessary scene data are counted up (Step S126) and decides whether or not a characteristic whose selection count value is equal to or greater than a predetermined value exists (Step S127).

Then, if such a characteristic is decided to exist in Step S127, characteristic parameter reference information 33 is updated in a manner that a standard range of a parameter corresponding to the matching characteristic is widened (Step S128), and the processing is finished. On the other hand, in Step S127, if such a characteristic is decided not to exist, the processing is finished.

### Advantages of Fourth Embodiment

In the fourth embodiment as set forth above, the following advantages can be obtained in addition to the advantages similar to the first to third embodiments.

The editing device 100D suitably updates the characteristic reference value information 31 based on the result of the selection of the unnecessary scene data by the user.

Specifically, the characteristic reference value information 31 is updated in a manner that the standard range of the characteristic that corresponds to the abandoned unnecessary scene is narrowed, in other words, updated in a manner that a scene is more easily identified as an unnecessary scene. In addition, the characteristic reference value information 31 is updated in a manner that the standard range of the characteristic that corresponds to the unnecessary scene selected as a selection scene is widened, in other words, updated in a manner that a scene is less easily identified as an unnecessary scene. Then, based on such updated characteristic reference value information 31, the video data is identified as the unnecessary scene data and the necessary scene data.

With the above arrangement, because preference of the user is reflected to the identification standard of an unnecessary scene, an unnecessary scene can be recognized in a manner better matching the preference of the user. Accordingly, the choose-and-discard operation is made more efficient and less worrisome for the user.

### Modifications of Embodiments

Incidentally, the invention is not limited to the above-described embodiments, but includes the following modifications as far as an object of the invention is achieved.

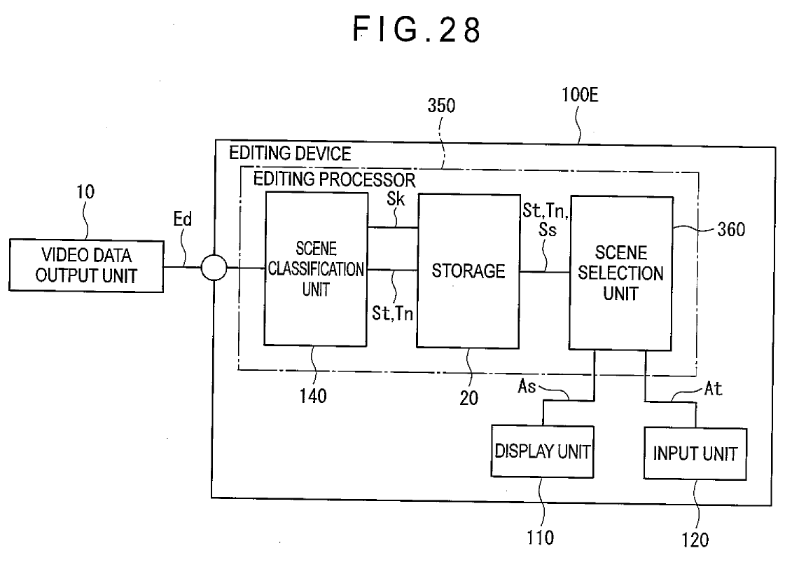

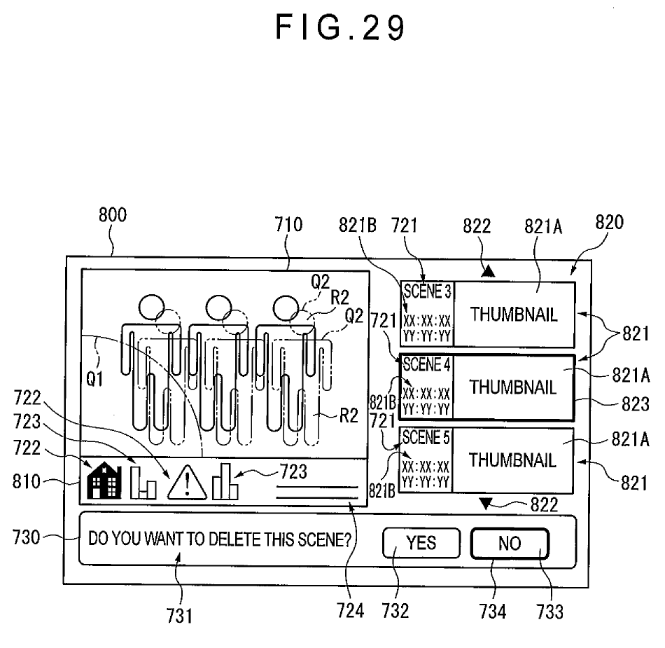

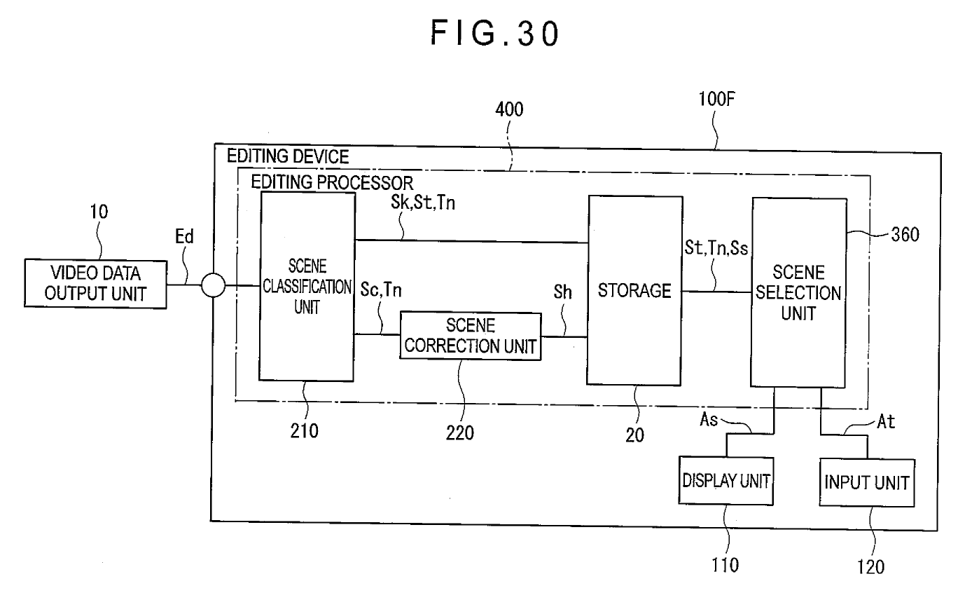

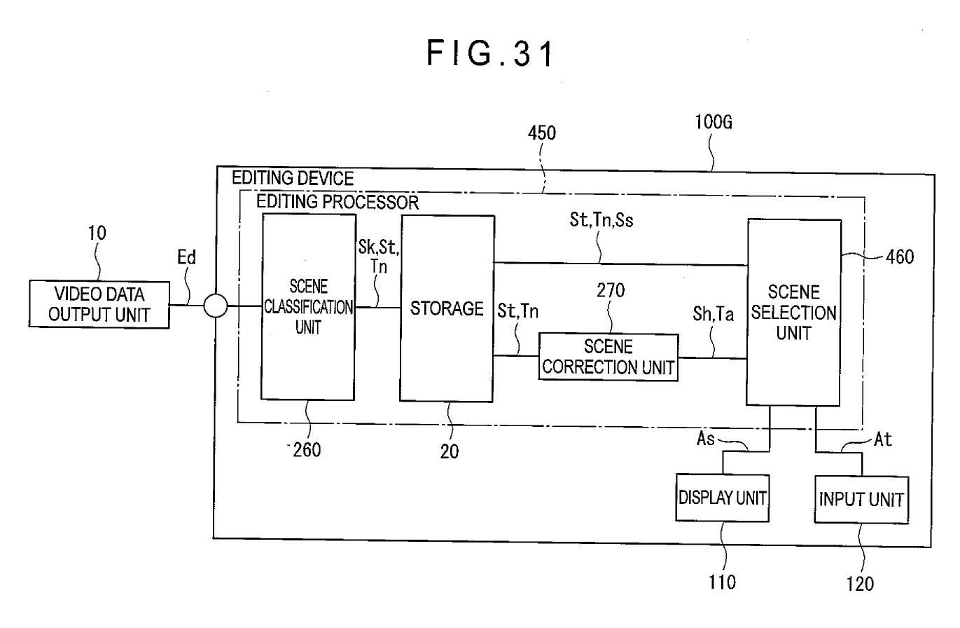

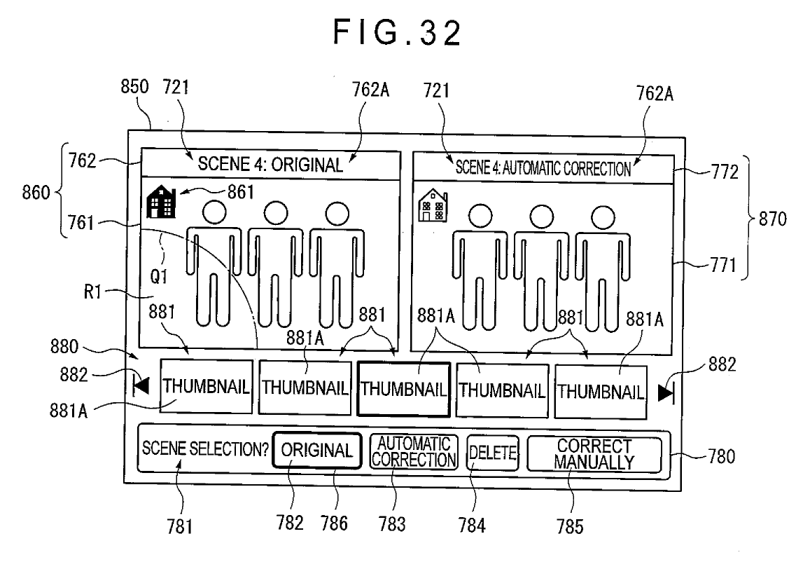

For example, arrangements similar to the editing devices 100A, 100B, and 100C of the first, second, and third embodiments may be employed to form a modification of the first embodiment as shown in FIGS. 28 and 29, a modification of the second embodiment as shown in FIG. 30, and a modification of the third embodiment as shown in FIGS. 31 and 32. Incidentally, the same arrangements as the first to third embodiments will be denoted with the same numerals and the same names, and the description thereof will be omitted or simplified.

As shown in FIG. 28, the editing device 100E as the data processor of the modification of the first embodiment includes a display unit 110, an input unit 120, and an editing processor 350. The editing processor 350 includes a scene classification unit 140 as shown in FIG. 2, a storage 20, and a scene selection unit 360.

The characteristic comparison unit 146 and the classification distribution unit 147 of the scene classification unit 140 are connected to the storage 20 and stores the scene attribute information 50, the unnecessary scene data, and the necessary scene data in the storage 20.

The scene selection unit 360 has an arrangement (not shown) of the scene selection unit 150 as shown in FIG. 5 without the storage unit 152. The abstract reproduction unit 153 and the selection distribution unit 155 are connected to the storage 20. The scene selection unit 360 suitably obtains the scene attribute information 50 and the unnecessary scene data from the storage 20 and stores the selection scene data selected in the scene selection processing in the storage 20.

Also, when scene identification processing is conducted, the GUI 154 of the scene selection unit 360 displays the delete selection screen 800 as shown in FIG. 29.

The delete selection screen 800 includes: a reproduction video area 710 provided from a substantially central portion to the vicinity of an upper left periphery; a scene attribute area 810 provided under the reproduction video area 710; a stored unnecessary scene area 820 provided to the right of the reproduction video area 710; and a selection manipulation area 730 provided under the reproduction video area 710.

The scene attribute area 810 displays an icon 722, characteristic graph information 723, and characteristic character string information 724.

The stored unnecessary scene area 820 includes three individual unnecessary scene areas 821 positioned head to tail in an up-down direction, each relating to one unnecessary scene. The individual unnecessary scene area 821 displays a thumbnail 821A of an unnecessary scene, scene number information 721, and reproduction time information 821B of the unnecessary scene. Further, scroll buttons 822 for scrolling contents of the individual unnecessary scene area 821 are displayed over and under the stored unnecessary scene area 820.

Also, a cursor 823 is displayed on a periphery of the individual unnecessary scene area 821 selected by the user. Here, contents that correspond to the individual unnecessary scene area 821 surrounded by the cursor 823 is displayed on the reproduction video area 710 and the scene attribute area 810.

As shown in FIG. 30, the editing device 100F as the data processor of the modification of the second embodiment includes a display unit 110, an input unit 120, and an editing processor 400. The editing processor 400 includes a scene classification unit 210 as shown in FIG. 13, a scene correction unit 220, a storage 20, and a scene selection unit 360.

The characteristic comparison unit 211 and the classification distribution unit 212 of the scene classification unit 210 are connected to the storage 20 to store the scene attribute information 50, the unnecessary scene data, and the necessary scene data in the storage 20, and output the scene attribute information 50 and the correctable scene data to the scene correction unit 220.

As shown in Fig, 31, the editing device 100G as the data processor of the modification of the third embodiment includes a display unit 110, an input unit 120, and an editing processor 450. The editing processor 450 includes a scene classification unit 260 as shown in FIG. 17, a scene correction unit 270, a storage 20, and a scene selection unit 460.

The characteristic comparison unit 261 and the classification distribution unit 262 of the scene classification unit 260 are connected to the storage 20 and stores the scene attribute information 50, the unnecessary scene data, and the necessary scene data in the storage 20.

The scene correction unit 270 is connected to the storage 20 and the scene selection unit 460, and suitably obtains the scene attribute information 50 and the unnecessary scene data from the storage 20 to correct the unnecessary scene data. Then, the correction scene data and the corrected scene attribute information are outputted to the scene selection unit 460.

The scene selection unit 460 has an arrangement (not shown) of the scene selection unit 280 as shown in FIG. 18 without the storage unit 281. The abstract reproduction unit 282 and the selection distribution unit 284 are connected to the storage 20. The scene selection unit 460 suitably obtains the scene attribute information 50, the unnecessary scene data, the correction scene attribute information, and correction scene data, and stores selection scene data selected in the scene selection processing in the storage 20.

Also, when scene identification processing is conducted, the GUI 283 of the scene selection unit 460 displays the delete selection screen 850 as shown in FIG. 32.

The delete selection screen 850 includes: an unnecessary scene area 860 provided in the left side; a correction scene area 870 provided to the right of the unnecessary scene area 860; a stored unnecessary correction scene area 880 provided under these areas; and a selection manipulation area 780 provided under the stored unnecessary correction scene area 880.

The unnecessary scene area 860 includes: a reproduction display area 761; and a scene identification area 762 provided over the reproduction display area 761. The reproduction display area 761 displays an icon 861 in addition to video of the unnecessary scene.

The correction scene area 870 is provided in manner similar to each of the reproduction display area 761 and the scene identification area 762 of the unnecessary scene area 860 and includes a reproduction display area 771 and a scene identification area 772 that display information similar to the reproduction display area 761 and the scene identification area 762.

Five of the stored unnecessary correction scene areas 880 are provided side by side in a left-right direction and includes a thumbnail area 881 that displays a thumbnail 881A of one unnecessary scene. Scroll buttons 882 for scrolling contents of the thumbnail area 881 are displayed on the right side and the left side of the stored unnecessary correction scene area 880.

Also, a cursor 883 is displayed on a periphery of the thumbnail area 881 selected by the user. Here, contents that correspond to the thumbnail area 881 surrounded by the cursor 883 is displayed on the unnecessary scene area 860 and the correction scene area 870.

In the modifications of the first to third embodiments, the editing device 100E, 100F, 100 is provided with the storage 20, thereby having an arrangement capable of independently conducting scene classification processing and scene selection processing.

Accordingly, it is no longer required to provide the storage unit 152, 281 to the scene selection unit 360, 460, so that the arrangement of the scene selection unit 360, 460 can be simplified. In addition, the user can conduct a choose-and-discard operation suitably at a favorable timing, thereby further improving convenience. Furthermore, time required for the choose-and-discard operation is reduced.

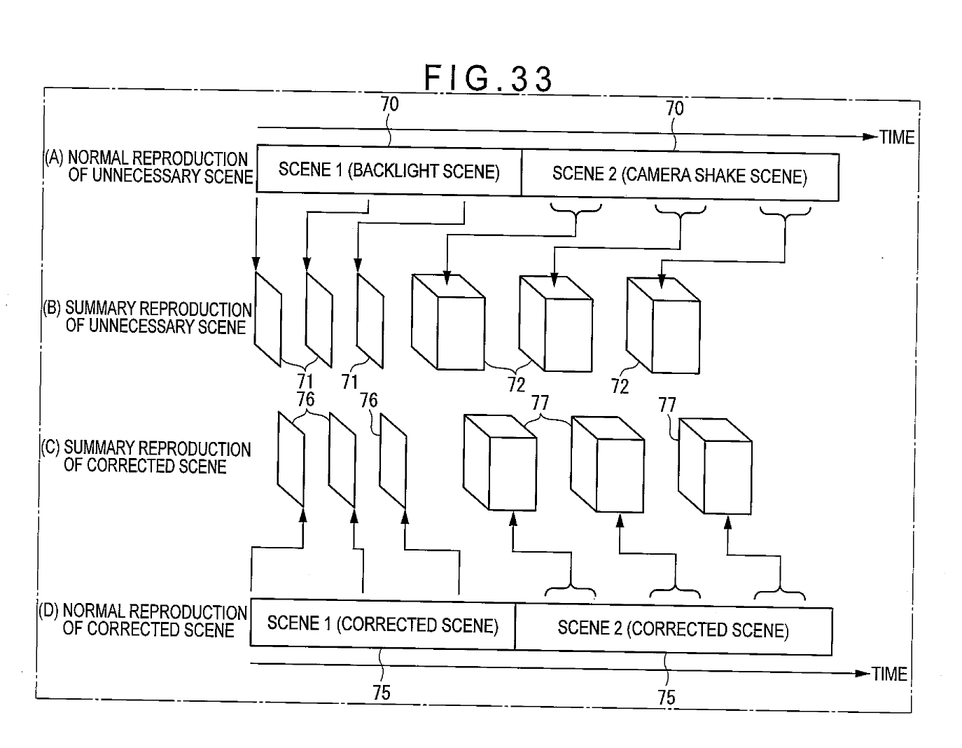

Next, the normal reproduction processing and the abstract reproduction processing of the unnecessary scene and the correction scene in the third embodiment may include processing as shown in FIG. 33.

In other words, as shown in FIGS. 33(A) and (D), the normal reproduction processing is conducted similarly to the third embodiment. On the other hand, as shown in FIGS. 33(B) and (C), unnecessary scenes and correction scenes are alternately reproduced in the abstract reproduction processing.

In this case, when alternate reproduction is conducted, one of the unnecessary scene and the correction scene may be paused while the other is reproduced, for example.

With this arrangement, the split of attention point caused by simultaneously gazing the unnecessary scene and the correction scene can be prevented, thereby achieving a more appropriate choose-and-discard operation.

The characteristic analysis unit 144 includes three units of the color characteristic analysis unit 144A, the action characteristic analysis unit 144B, and the spatial frequency characteristic analysis unit 144C in the above-described embodiments, but an arrangement having at least one of the three may be employed. Alternatively, an analysis unit of a different kind may be provided.

In addition, the color characteristic analysis unit 144A analyzes a plurality of characteristics such as histograms of brightness, tone, and saturation of color in the above-described embodiments, but an arrangement in which at least one of the characteristics is analyzed may be employed.

Further, the action characteristic analysis unit 144B recognizes a plurality of characteristics such as camera work during capturing operation and the action area independent of camera work in the above-described arrangement, but an arrangement in which at least one of the characteristics are recognized may be employed.

The spatial frequency characteristic analysis unit 144C recognizes the low frequency area from the local frequency characteristic analysis result in the above-described arrangement, but an arrangement in which a high frequency area is recognized may be employed.

Also, an arrangement in which the abstract reproduction unit 153 or 282 only includes either of the normal reproduction function and the abstract reproduction function of the unnecessary scenes may be employed.

Further, an arrangement in which the abstract reproduction function only includes either of the function of abstract reproduction in still images and the function of abstract reproduction in motion images may be employed.

Still further, an arrangement in which, when abstract reproduction is conducted in motion images, an unnecessary scene such as one with a prominent high-speed pan is not extracted but a predetermined scene such as a scene after a predetermined time period from the start of the unnecessary scene is extracted may be employed.

With these arrangements, arrangements of the abstract reproduction unit 153, 282 can be simplified, and processing burden in the reproduction processing can be reduced.

In addition, whereas an arrangement in which the scene correction unit 220, 270 corrects the correctable scene data and the unnecessary scene data based on the scene attribute information 50 is exemplified above, the following arrangements may also be employed.

Specifically, an arrangement in which the scene correction unit 220, 270 includes a function for analyzing a characteristic of correctable scene data or unnecessary scene data but does not include a function for obtaining the scene attribute information 50 may be employed.

Further, whereas an arrangement in which, when an unnecessary scene is reproduced, an attribute and a characteristic value are displayed in combination is exemplified above, an arrangement in which these are not displayed or an arrangement in which either one of these is displayed may be employed.

With these arrangements, an amount of information displayed on the delete selection screen 700, 750, 800, 850 can be reduced, thereby improving visible recognizability of unnecessary scenes.

Whereas the above-described functions are constructed in a form of a program, the functions may be arranged in a hardware such as a circuit board or an element such as an IC (integral circuit). In other words, implementation may take any form. Note that if an arrangement in which a computer (i.e., arithmetic device) reads out the function from a program or from a suitable separate recording media is employed, operation is facilitated and wide utilization is easily achieved.

Other than what has been described, a specific structure and a procedure upon implementation of the invention may be suitably modified in another structure or the like as long as an object of the invention is achieved.

### Advantages of Embodiments

As set forth above, in the embodiments, the editing device 100A selects, among the video of the video data, a scene such as a backlit scene and a camera shake scene which has a characteristic different from a necessary scene, as an unnecessary scene. The unnecessary scene is reproduced in the display unit 110.

Accordingly, the editing device 100A allows the user to select necessary scenes and unnecessary scene from among the camera shake scenes or the backlit scenes. In addition, for example, if a camera shake scene is present in similar videos that are captured at substantially identical locations, the user can recognize that the camera scene is present without conducting an operation to select the camera shake scene.

### INDUSTRIAL APPLICABILITY

The present invention can be applied to a data processor for processing video data of captured data, a method for the same, a program of the same, and a recording medium on which the program is recorded.

1. A data processor that processes video data for displaying video captured by a capturing device, comprising:
a video data obtainment unit that obtains the video data;
a characteristic analysis unit that analyzes a characteristic of video of the video data obtained;
an identification unit that identifies, as an unnecessary scene, a scene of the characteristic that is obtained by analyzing and is out of a range of a predetermined reference value;
a selection unit that selects, from the video data, unnecessary scene data for displaying the unnecessary scene;
a display control unit that controls a display unit to display the unnecessary scene based on the unnecessary scene data selected;
a necessity decision unit that decides, based on an input manipulation of an input unit, whether or not the predetermined scene data is necessary;
a reference information storage unit that stores reference information regarding a reference value range of the characteristic for identification of the unnecessary scene; and
a reference information update unit that changes the reference value range of the reference information regarding the characteristic that forms a source of identification of the predetermined unnecessary scene data as the unnecessary scene based on a result of decision of the necessity decision unit regarding the predetermined unnecessary scene data.

2. The data processor according to claim 1, wherein
the characteristic analysis unit includes at least one analysis unit selected from: an action characteristic analysis unit that analyzes a characteristic regarding an action; a color characteristic analysis unit that analyzes a characteristic regarding intensity distribution of at least one of luminance and chromaticity; and a spatial frequency characteristic analysis unit that analyzes a distribution characteristic regarding spatial frequency, and
the identification unit detects that at least one characteristic obtained as a result of analyzing by the at least one analysis unit is out of the range of the predetermined standard range that corresponds to the characteristic to identify a scene having the at least one characteristic as the unnecessary scene.

3. The data processor according to claim 2, wherein
the video data has an arrangement in which a plurality of image data for displaying a predetermined image are associated in a displaying order, and
in displaying the unnecessary scene, when the characteristic identified as the unnecessary scene by the identification unit includes the characteristic analyzed by the action characteristic analysis unit, the display control unit controls at least a portion of the unnecessary scene to be displayed as a motion image based on the plurality of image data that are continuous with respect to the displaying order and are included in the unnecessary scene data.

4. The data processor according to claim 3, wherein
the display control unit controls a scene in which the action characteristic of the unnecessary scene is greatly apart from the range of the reference value to be displayed as the motion image.

5. The data processor according to claim 2, wherein
the display control unit, when displaying the unnecessary scene of which the characteristic obtained as a result of analyzing by the at least one of the color characteristic analysis unit and the spatial frequency characteristic analysis unit is out of the range of the predetermined reference value that corresponds to the characteristic, controls at least a portion of the unnecessary scene to be displayed as a still image.

6. The data processor according to claim 1, further comprising:
an editing data creation unit that creates, as editing data, the video data not including the unnecessary scene data that is decided to be unnecessary by the necessity decision unit.

7. The data processor according to claim 1, wherein
the unnecessary scene includes: an uncorrectable scene in which a degree by which the characteristic is apart from the range of the reference value is greater than a predetermined degree; and a correctable scene in which the degree by which the characteristic is apart from the range of the reference value is smaller than the predetermined degree, and
the display control unit controls the uncorrectable scene to be displayed based on the unnecessary scene data of the uncorrectable scene, further comprising:
a necessity decision unit that decides, based on an input manipulation of an input unit, whether or not the unnecessary scene data of the predetermined uncorrectable scene is necessary;
a correction unit that creates correction scene data formed by correcting the characteristic of the correctable scene based on the unnecessary scene data of the correctable scene; and
an editing data creation unit that creates, as editing data, the video data not including the unnecessary scene data that is decided to be unnecessary by the necessity decision unit but including the correction scene data.

8. The data processor according to claim 1, further comprising:
a correction unit that creates correction scene data for displaying a correction scene formed by correcting the characteristic of the unnecessary scene based on the unnecessary scene data, wherein
the display control unit controls the unnecessary scene based on the unnecessary scene data and the correction scene based on the correction scene data that corresponds to the unnecessary scene data to be displayed.

9. The data processor according to claim 8, further comprising
a necessity decision unit that decides, based on an input manipulation of the input unit, that one of the unnecessary scene data and the correction scene data that corresponds to the unnecessary scene data is necessary or that the unnecessary scene data and the correction scene data that corresponds to the unnecessary scene data are unnecessary; and
an editing data creation unit that creates, as editing data, the video data including the one of the unnecessary scene data and the correction scene data decided to be necessary by the necessity decision unit but not including the data that is decided to be unnecessary by the necessity decision unit.

10. The data processor according to claim 7, wherein
the correction unit recognizes a content of a characteristic that is out of the range of the reference value in the unnecessary scene and creates the correction scene data for displaying the correction scene corrected according to the content recognized.

11. The data processor according to claim 1,
wherein
the identification unit obtains the reference information from the reference information storage unit and identifies the unnecessary scene based on the reference information.

12. (canceled)

13. The data processor according to claim 1, wherein
the display control unit controls the display unit to display characteristic content information regarding the content of the characteristic that is out of the range of the reference value in the unnecessary scene.

14. A data processing method for a computer to process video data for displaying video captured by a capturing device, comprising:
obtaining the video data by the computer;
analyzing a characteristic of video of the video data obtained by the computer;
identifying a scene of a characteristic that is obtained by the analyzing and is out of a range of a predetermined reference value as an unnecessary scene by the computer;
selecting, from the video data, unnecessary scene data for displaying the unnecessary scene by the computer;
controlling the display unit to display the unnecessary scene based on the unnecessary scene data selected by the computer;
deciding, based on an input manipulation of an input unit, whether or not the predetermined scene data is necessary by the computer;
storing reference information regarding a reference value range of the characteristic for identification of the unnecessary scene by the computer; and
changing the reference value range of the reference information regarding the characteristic that forms a source of identification of the predetermined unnecessary scene data as the unnecessary scene based on a result of decision regarding whether or not the predetermined unnecessary scene data is necessary by the computer.

15. A data processing program, wherein the data processing method according to claim 14 is executed on a computer.

16. A recording media on which a data processing program is recorded, wherein the data processing program according to claim 15 is recorded in a manner readable by a computer.

17. The data processor according to claim 8, wherein
the correction unit recognizes a content of a characteristic that is out of the range of the reference value in the unnecessary scene and creates the correction scene data for displaying the correction scene corrected according to the content recognized.
